(19) United States
(12) Patent Application Publication
(10) Pub. No.: US 2026/0369264 A1
(43) Pub. Date: Nov. 19, 2026

(54) ELECTRONIC DEVICE AND METHOD FOR INTERPRETATION DURING CALL, AND STORAGE MEDIUM

(71) Applicant: Samsung Electronics Co., Ltd., Suwon-si (KR)

(72) Inventors: Yanghee KWON, Suwon-si (KR); Jaegi HAN, Suwon-si (KR); Sungwon PARK, Suwon-si (KR); Seowon CHOI, Suwon-si (KR); Hyunkyoung KIM, Suwon-si (KR); Wanje PARK, Suwon-si (KR); Dongil SON, Suwon-si (KR)

(21) Appl. No.: 19/725,771

(22) Filed: Jun. 30, 2026

Related U.S. Application Data
(63) Continuation of application No. PCT/KR2024/021030, filed on Dec. 24, 2024.

(30) Foreign Application Priority Data
Jan. 2, 2024 (KR) 10-2024-0000558
Mar. 6, 2024 (KR) 10-2024-0032202

(51) Int. Cl. G10L 13/08; G06F 40/58; G10L 15/26

(52) U.S. Cl. CPC G10L 13/08; G06F 40/58; G10L 15/26

(57) ABSTRACT

An electronic device is provided. The electronic device includes a communication interface, a display, a speaker, at least one processor, and memory, comprising one or more storage media, storing instructions, wherein the instructions, when executed by the at least one processor individually or collectively, cause the electronic device to convert an utterance of a counterpart in a first language into first text, and display the first text on a script screen on the display during a call, translate the first text into a second language to generate second text, and display the second text together with the first text on the script screen, convert the second text into a first text-to-speech (TTS) audio signal, in case that a first mute option for the utterance of the counterpart is enabled, identify the utterance of the counterpart, and output the first TTS audio signal through the speaker without outputting the utterance of the counterpart, and in case that the first mute option for the utterance of the counterpart is disabled, output the utterance of the counterpart and the first TTS audio signal through the speaker.

### CROSS-REFERENCE TO RELATED APPLICATION(S)

This application is a continuation application, claiming priority under 35 U.S.C. § 365(c), of an International application No. PCT/KR2024/021030, filed on Dec. 24, 2024, which is based on and claims the benefit of a Korean patent application number 10-2024-0000558, filed on Jan. 2, 2024, in the Ministry of Intellectual Property (MOIP), and of a Korean patent application number 10-2024-0032202, filed on Mar. 6, 2024, in the Ministry of Intellectual Property (MOIP), the disclosure of each of which is incorporated by reference herein in its entirety.

### BACKGROUND

### 1. Field

The disclosure relates to an electronic device, a method, and a storage medium for interpretation during a call.

### 2. Description of Related Art

As transportation and communication evolve, interactions with non-native speakers continue to grow. To facilitate such interactions, communication through a mutually understandable language is required. For example, if individuals from different linguistic backgrounds are able to speak a common language (e.g., English or French), the individuals can communicate using the common language. Alternatively, if one person (or a group of people) is able to speak a counterpart's language, communication is possible using the counterpart's language. However, if people from different linguistic backgrounds are not familiar with a common language or each other's language, people may communicate with the assistant of an interpreter.

The above information is presented as background information only to assist with an understanding of the disclosure. No determination has been made, and no assertion is made, as to whether of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device, a method, and a storage medium for translation during a call.

Additional aspects will be set forth in part in the description which follows and, in part, will be apparent from the description, or may be learned by practice of the presented embodiments.

In accordance with an aspect of the disclosure, an electronic device is provided. The electronic device includes a communication interface, a display, a speaker, at least one processor, and memory, comprising one or more storage media, storing instructions wherein the instructions, when executed by the at least one processor individually or collectively, cause the electronic device to convert an utterance of a counterpart in a first language into first text, and display the first text on a script screen on the display during a call, translate the first text into a second language to generate second text and display the second text together with the first text on the script screen, convert the second text into a first text-to-speech (TTS) audio signal, in case that a first mute option for the utterance of the counterpart is enabled, identify the utterance of the counterpart and output the first TTS audio signal through the speaker without outputting the utterance of the counterpart, and in case that the first mute option for the utterance of the counterpart is disabled, output the utterance of the counterpart and the first TTS audio signal through the speaker.

In accordance with another aspect of the disclosure, a method performed by an electronic device including a screen is provided. The method includes converting an utterance of a counterpart in a first language into first text and displaying the first text on a script screen during a call, translating the first text into a second language to generate second text and displaying the second text together with the first text on the script screen, converting the second text into a first text-to-speech (TTS) audio signal, in case that a first mute option for the utterance of the counterpart is enabled, identifying the utterance of the counterpart and outputting the first TTS audio signal without outputting the utterance of the counterpart, and in case that the first mute option for the utterance of the counterpart is disabled, outputting the utterance of the counterpart and the first TTS audio signal.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include converting an utterance of a counterpart in a first language into first text and displaying the first text on a script screen during a call, translating the first text into a second language to generate second text and displaying the second text together with the first text on the script screen, converting the second text into a first text-to-speech (TTS) audio signal, in case that a first mute option for the utterance of the counterpart is enabled, identifying the utterance of the counterpart and outputting the first TTS audio signal without outputting the utterance of the counterpart, and in case that the first mute option for the utterance of the counterpart is disabled, outputting the utterance of the counterpart and the first TTS audio signal.

Various embodiments of the disclosure optionally provide an interpretation function during a call according to a user's selection.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a block diagram illustrating a configuration of an electronic device according to an embodiment of the disclosure;

FIGS. 3A, 3B, 3C, 3D, 3E, 3F, 3G, and 3H are diagrams illustrating an operation of installing language data according to various embodiments of the disclosure;

FIGS. 4A, 4B, 4C, 4D, 4E, 4F, 4G, 4H, 4I, and 4J are diagrams illustrating an operation of configuring a language of a counterpart according to various embodiments of the disclosure;

FIG. 5A is a flowchart illustrating an interpretation operation according to an embodiment of the disclosure;

FIG. 5B is a timing diagram illustrating an interpretation operation according to an embodiment of the disclosure;

FIGS. 6A, 6B, 6C, and 6D are diagrams illustrating an operation of executing an interpretation function during an outgoing call according to various embodiments of the disclosure;

FIGS. 7A, 7B, 7C, 7D, 7E, and 7F are diagrams illustrating an operation of executing an interpretation function during an incoming call according to various embodiments of the disclosure;

FIG. 8 is a diagram illustrating an utterance option according to an embodiment of the disclosure;

FIGS. 9A, 9B, 9C, and 9D are diagrams illustrating an interpretation operation displayed on a conversation script according to various embodiments of the disclosure;

FIG. 10A and FIG. 10B are diagrams illustrating a conversation script displaying an utterance and a translation according to various embodiments of the disclosure;

FIG. 11 is a flowchart illustrating an operation of performing an interpretation function, based on information about a counterpart identified through a server according to an embodiment of the disclosure;

FIGS. 12A and 12B are diagrams illustrating an operation of configuring a language of a counterpart, based on number information about the counterpart according to various embodiments of the disclosure;

FIGS. 13A, 13B, and 13C are diagrams illustrating an operation of configuring a language of a counterpart, based on additional information according to various embodiments of the disclosure;

FIGS. 14A, 14B, 14C, 14D, and 14E are diagrams illustrating a screen displayed on an electronic device of a user when an interpretation function is executed according to various embodiments of the disclosure;

FIGS. 15A and 15B are diagrams illustrating a screen displayed on an electronic device of a counterpart when an interpretation function is executed according to various embodiments of the disclosure;

FIG. 16A is a diagram illustrating a conversation script screen including a configuration option according to an embodiment of the disclosure;

FIG. 16B is a diagram illustrating volume of an utterance and/or a TTS audio signal according to an embodiment of the disclosure;

FIGS. 17A and 17B are flowcharts illustrating an operation in which an electronic device of a user and an electronic device of a counterpart execute an interpretation function together according to various embodiments of the disclosure;

FIG. 18 is a timing diagram illustrating an operation in which an electronic device of a user and an electronic device of a counterpart execute an interpretation function together according to an embodiment of the disclosure;

FIGS. 19A, 19B, and 19C are diagrams illustrating an operation of modifying text displayed on a conversation script according to various embodiments of the disclosure;

FIGS. 20A, 20B, and 20C are diagrams illustrating an operation of modifying text displayed in a call history according to various embodiments of the disclosure;

FIGS. 21A and 21B are diagrams illustrating an operation of executing an interpretation function in a conference call according to various embodiments of the disclosure; and

FIG. 22 is a flowchart illustrating an interpretation method during a call according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

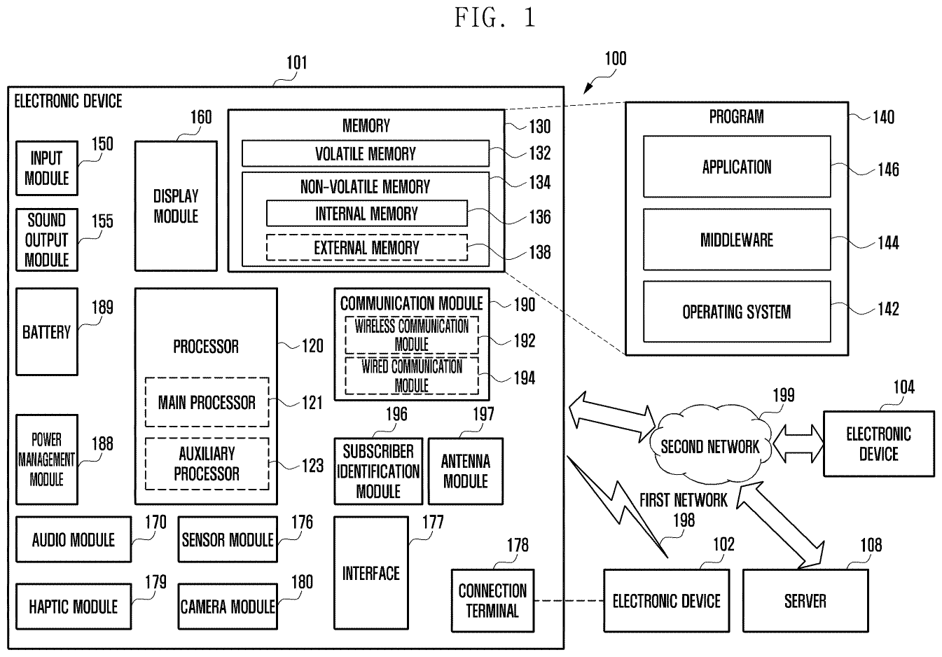

FIG. 1 is a block diagram illustrating an electronic device 101 in a network environment 100 according to an embodiment of the disclosure. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an example, the electronic device 101 may communicate with the electronic device 104 via the server 108. According to an example, the electronic device 101 may include a processor 120, memory 130, an input module 150, a sound output module 155, a display module 160, an audio module 170, a sensor module 176, an interface 177, a connection terminal 178, a haptic module 179, a camera module 180, a power management module 188, a battery 189, a communication module 190, a subscriber identification module (SIM) 196, or an antenna module 197. In some examples, at least one of the components (e.g., the connection terminal 178) may be omitted from the electronic device 101, or one or more other components may be added in the electronic device 101. In some examples, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one example, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an example, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an example, the auxiliary processor 123 (e.g., an image signal processor or a communication processor) may be implemented as part of another component (e.g., the camera module 180 or the communication module 190) functionally related to the auxiliary processor 123. According to an example, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134. The non-volatile memory may include at least one of an internal memory 136 and an external memory 138.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an example, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an example, the display module 160 may include a touch sensor adapted to detect a touch, or a pressure sensor adapted to measure the intensity of force incurred by the touch.

The audio module 170 may convert a sound into an electrical signal and vice versa. According to an example, the audio module 170 may obtain the sound via the input module 150, or output the sound via the sound output module 155 or a headphone of an external electronic device (e.g., the electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an example, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an example, the interface 177 may include, for example, a high definition multimedia interface (HDMI), a universal serial bus (USB) interface, a secure digital (SD) card interface, or an audio interface.

The connection terminal 178 may include a connector via which the electronic device 101 may be physically connected with the external electronic device (e.g., the electronic device 102). According to an example, the connection terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an example, the haptic module 179 may include, for example, a motor, a piezoelectric element, or an electric stimulator.

The camera module 180 may capture a still image or moving images. According to an example, the camera module 180 may include one or more lenses, image sensors, image signal processors, or flashes.

The power management module 188 may manage power supplied to the electronic device 101. According to one example, the power management module 188 may be implemented as at least part of, for example, a power management integrated circuit (PMIC).

The battery 189 may supply power to at least one component of the electronic device 101. According to an example, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an example, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an example, the wireless communication module 192 may support a peak data rate (e.g., 20 gigabits per second (Gbps) or more) for implementing eMBB, loss coverage (e.g., 164 decibels (dB) or less) for implementing mMTC, or user plane (U-plane) latency (e.g., 0.5 milliseconds (ms) or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an example, the antenna module 197 may include an antenna including a radiating element composed of a conductive material or a conductive pattern formed in or on a substrate (e.g., a printed circuit board (PCB)). According to an example, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an example, another component (e.g., a radio frequency integrated circuit (RFIC)) other than the radiating element may be additionally formed as part of the antenna module 197.

According to various examples, the antenna module 197 may form an mmWave antenna module. According to an example, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an example, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an example, all or some of operations to be executed at the electronic device 101 may be executed at one or more of the external electronic devices (e.g. electronic devices 102 and 104 or the server 108). For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an example, the external electronic device 104 may include an internet-of-things (IoT) device. The server 108 may be an intelligent server using machine learning and/or a neural network. According to an example, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various examples may be one of various types of electronic devices. The electronic devices may include, for example, a portable communication device (e.g., a smartphone), a computer device, a portable multimedia device, a portable medical device, a camera, a wearable device, or a home appliance. According to an example of the disclosure, the electronic devices are not limited to those described above.

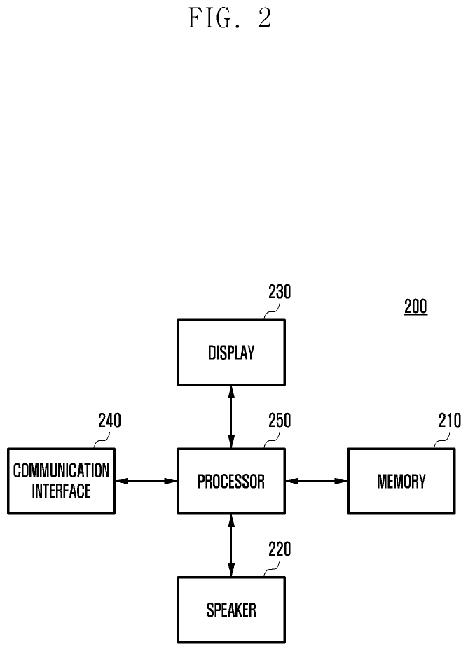

FIG. 2 is a block diagram illustrating a configuration of an electronic device according to an embodiment of the disclosure.

Referring to FIG. 2, the electronic device 200 (e.g., the electronic device 101 in FIG. 1) may include memory 210, a speaker 220, a display 230, a communication interface 240, and a processor 250.

The memory 210 (e.g., the memory 130 of FIG. 1) may store data, algorithms, programs, and/or instructions to perform a function of the electronic device 200 (e.g., the electronic device 101 of FIG. 1). The instructions stored in the memory 210 may be loaded into the processor 250 and executed by the processor 250. For example, the memory 210 may store language data configured in a user's language and/or a counterpart's language. The language data may include a language pack, and the language pack may be received from a server (e.g., the server 108 of FIG. 1).

The speaker 220 (e.g., the audio output module 155 of FIG. 1) may output an utterance and/or a text-to-speech (TTS) audio signal. For example, the utterance may include an utterance of the user and/or an utterance of the counterpart. The TTS audio signal may include a first TTS audio signal generated based on a translation of the user's utterance and a second TTS audio signal generated based on a translation of the counterpart's utterance. In the disclosure, terms such as “first” or “second” may be used only to distinguish a component from another component, and do not limit the corresponding components in other aspects (e.g., importance or order).

The display 230 (e.g., the display module 160 of FIG. 1) may display a user interface (UI) associated with an interpretation function and/or a conversation script. For example, the conversation script may include first text converted from the user's utterance, second text obtained by translating the user's utterance (or the first text), third text converted from the counterpart's utterance, and/or fourth text obtained by translating the counterpart's utterance (or the third text).

The communication interface 240 (e.g., the communication module 190 of FIG. 1) may transmit the user's utterance and/or the first TTS audio signal (e.g., an audio signal obtained by translating the user's utterance) to an electronic device of the counterpart, and may receive the counterpart's utterance and/or the second TTS audio signal (e.g., an audio signal obtained by translating the counterpart's utterance) from the electronic device of the counterpart. In an example, when only the electronic device of the user performs the interpretation function, the communication interface 240 may receive only the counterpart's utterance from the electronic device of the counterpart. In an example, when the user's electronic device and the counterpart's electronic device (e.g., the electronic devices 102 and 104 of FIG. 1) perform the interpretation function together, the communication interface 240 may transmit/receive TTS audio signals (e.g., the first and second TTS audio signals) and transmit/receive utterance signals (e.g., the user's utterance and the counterpart's utterance).

The processor 250 (e.g., the processor 120 of FIG. 1) may control each component of the electronic device 200. The electronic device 200 may include one or more processors 250. For example, the processor 250 may correspond to a plurality of processors that collectively perform a plurality of functions in a distributed manner among the processors.

In an example, the electronic device 200 may execute the interpretation function between electronic devices without the server. When the electronic device 200 executes the interpretation function without the server, the electronic device 200 may translate the user's utterance and the counterpart's utterance, based on information identifiable by the electronic device 200 and/or information configured in the electronic device 200. The electronic device 200 may transmit the user's utterance and/or a first TTS audio signal generated based on the user's utterance to the counterpart's electronic device, and may output the counterpart's utterance and/or a second TTS audio signal generated based on the counterpart's utterance.

In an example, the electronic device 200 may execute the interpretation function via the server. When the electronic device 200 executes the interpretation function via the server, the electronic device 200 may execute the interpretation function, based on information identified through the server, information identified by the electronic device 200, and/or information configured in the electronic device 200. When the counterpart's electronic device supports the interpretation function, the electronic device 200 of the user and the electronic device of the counterpart may execute the interpretation function together.

For example, the electronic device 200 of the user may translate the user's utterance, and may generate a first TTS audio signal, based on the translated user's utterance. The electronic device 200 of the user may transmit the user's utterance and/or the first TTS audio signal to the electronic device of the counterpart. The electronic device of the counterpart may translate the counterpart's utterance, and may generate a second TTS audio signal, based on the translated counterpart's utterance. The electronic device of the counterpart may transmit the counterpart's utterance and/or the second TTS audio signal to the electronic device 200 of the user.

In another example, the electronic device 200 of the user may transmit the user's utterance to the electronic device of the counterpart. The electronic device of the counterpart may translate the user's utterance, and may generate a first TTS audio signal, based on the translated user's utterance. The electronic device of the counterpart may output the user's utterance and/or the first TTS audio signal. The electronic device of the counterpart may transmit the counterpart's utterance to the electronic device 200 of the user. The electronic device 200 of the user may translate the counterpart's utterance, and may generate a second TTS audio signal, based on the translated counterpart's utterance. The electronic device 200 of the user may output the counterpart's utterance and/or the second TTS audio signal. Even though both the electronic device 200 of the user and the electronic device of the counterpart support the interpretation function, a single electronic device (e.g., the electronic device 200 of the user or the electronic device of the counterpart) may perform the interpretation function of translating all utterances and transmitting and outputting translation results.

The electronic device 200 of the user may interpret the user's utterance and the counterpart's utterance. The electronic device 200 of the user may generate text obtained by translating the user's utterance, and may convert the generated text into an audio signal by using a TTS method. In addition, the electronic device 200 of the user may generate text obtained by translating the received counterpart's utterance, and may convert the generated text into an audio signal by using the TTS method. The electronic device 200 of the user may output the counterpart's utterance and/or the TTS audio signal translated from the counterpart's utterance, and may transmit the user's utterance and/or the TTS audio signal translated from the user's utterance to the electronic device of the counterpart.

When the interpretation function is executed, the processor 250 may convert the user's utterance into first text, and may display the converted first text on the display 230. For example, the processor 250 may convert the user's utterance into the first text by using a speech-to-text (STT) method. The processor 250 may generate a conversation script, and may display texts generated in sequence on the conversation script. For example, the processor 250 may display the converted first text on the conversation script.

The processor 250 may translate the user's utterance into a second language to generate second text. For example, the second language may be a language configured as a language of the counterpart. The processor 250 may display the generated second text together with the displayed first text on the display 230. For example, the second text may be displayed in an area adjacent to the first text. A first language may include the language configured as the language of the counterpart or a default language. When the language of the counterpart is configured, the processor 250 may translate the user's utterance (or first text) into the language of the counterpart. When the language of the counterpart is not configured, the user's utterance may be translated into a language configured as the default language. For example, the first text may be text in which the user's utterance is displayed in a language of the user, and the second text may be text displayed by translating the user's utterance in the language of the counterpart or the default language.

For example, the language of the counterpart may be configured based on information about the counterpart. In an example, the processor 250 may identify a country code, an area code, system language information about the electronic device of the counterpart, and/or counterpart language information for a call application from a number of the counterpart. The processor 250 may determine a language, based on the identified information about the counterpart, and may configure the determined language as the counterpart's language. In an example, the processor 250 may identify a message received from the number of the counterpart, and may determine a language of the message. The processor 250 may configure the determined language of the message as the language of the counterpart. In an example, the processor 250 may determine the language of the counterpart from the counterpart's utterance.

The processor 250 may change the language of the counterpart from the second language to a third language according to an input of the user during a call with the counterpart. When the counterpart's language is changed, the processor 250 may translate (or interpret) the user's utterance into the third language. To translate the user's utterance into the counterpart's language, the processor 250 may need counterpart language data (e.g., a language pack). When the language of the counterpart is changed to the third language and there is no data of the third language, the processor 250 may control the communication interface 240 to download data of the third language from the server, and may store and install the downloaded data of the third language in the memory 210. When the data of the third language is installed, the processor 250 may translate the user's utterance into the third language to generate second text. The processor 250 may display the second text in the third language together with the first text displayed on the conversation script.

The processor 250 may convert the second text into a first TTS audio signal. The processor 250 may transmit the user's utterance and/or the first TTS audio signal to the electronic device of the counterpart through the communication interface 240. For example, the electronic device 200 may include a mute option for the user's utterance. When the mute option for the user's utterance is enabled, the processor 250 may not transmit the user's utterance to the electronic device of the counterpart, and may transmit only the converted first TTS audio signal to the electronic device of the counterpart. For example, when the mute option for the user's utterance is enabled, the processor 250 may not transmit the user's utterance to the communication interface 240, and may transmit only the converted first TTS audio signal to the communication interface 240. The communication interface 240 may transmit only the transmitted first TTS audio signal to the electronic device of the counterpart. When the mute option for the user's utterance is disabled, the processor 250 may transmit the user's utterance and/or the converted first TTS audio signal to the electronic device of the counterpart. For example, when the mute option for the user's utterance is disabled, the processor 250 may transmit the user's utterance and/or the converted first TTS audio signal to the communication interface 240. The communication interface 240 may transmit the transmitted user's utterance and/or the first TTS audio signal to the electronic device of the counterpart.

In an example, when the user speaks, the processor 250 may transmit the user's utterance to the communication interface 240, and may transmit the user's utterance to the electronic device of the counterpart through the communication interface 240. Further, when the first TTS audio signal is generated, the processor 250 may transmit the first TTS audio signal to the communication interface 240, and may transmit the first TTS audio signal to the electronic device of the counterpart through the communication interface 240. In an example, the processor 250 may record the user's utterance. In an example, when the user speaks, the processor 250 may activate a recording function. When the recording function is activated, the processor 250 may store an audio signal of the user's utterance in the memory 210 or a buffer. The processor 250 may transmit the user's utterance recorded when the first TTS audio signal is generated and the first TTS audio signal to the communication interface 240, and may simultaneously transmit the user's utterance and the first TTS audio signal to the electronic device of the counterpart through the communication interface 240.

The processor 250 may receive the counterpart's utterance through the communication interface 240. The processor 250 may convert the received counterpart's utterance into third text. The processor 250 may display the converted third text on the display 230. The processor 250 may translate the received counterpart's utterance into the configured language of the user to generate fourth text. The processor 250 may display the generated fourth text generated in an area adjacent to the displayed third text on the display 230. For example, the third text may be text in which the counterpart's utterance is displayed in the language of the counterpart, and the fourth text may be text displayed by translating the counterpart's utterance into the language of the user.

For example, the electronic device 200 may include a translation option for an utterance. When the translation option is disabled, the processor 250 may not translate the user's utterance and/or the counterpart's utterance.

In an example, to speak in the language of the counterpart, the user may turn off (or deactivate) the translation option for the user's utterance. When the translation option for the user's utterance is disabled, the processor 250 may transmit the user's utterance to the electronic device of the counterpart without translating the user's utterance. In addition, the processor 250 may display the first text on the conversation script while not displaying the second text.

In an example, when the user is able to understand the counterpart's language, the user may turn off a translation option for the counterpart's utterance. When the translation option for the counterpart's utterance is disabled, the processor 250 may output the counterpart's utterance without translating the counterpart's utterance. In addition, the processor 250 may display the third text on the conversation script while not displaying the fourth text.

The processor 250 may convert the fourth text into a second TTS audio signal. The processor 250 may output the counterpart' utterance and/or the converted second TTS audio signal through the speaker 220. For example, when a mute option for the counterpart's utterance is enabled, the processor 250 may identify the counterpart's utterance, and may not output the identified counterpart's utterance. For example, when the mute option for the counterpart's utterance is disabled, the processor 250 may output the counterpart's utterance and the converted second TTS audio signal.

For example, the processor 250 may output the counterpart's utterance when receiving the counterpart's utterance through the communication interface 240, and may output the second TTS audio signal when the second TTS audio signal is generated. In an example, when receiving the counterpart's utterance through the communication interface 240, the processor 250 may record the counterpart's utterance. In addition, when the second TTS audio signal is generated, the processor 250 may sequentially output the counterpart's utterance recorded when the second TTS audio signal is generated and the second TTS audio signal.

When the processor 250 outputs the counterpart's utterance and the second TTS audio signal, the processor 250 may sequentially output the counterpart's utterance and the second TTS audio signal. The processor 250 may output the counterpart's utterance at a second level of volume, and may output the second TTS audio signal at a third level of volume greater than the second level. In an example, the processor 250 may sequentially output the first TTS audio signal, the counterpart's utterance, and the second TTS audio signal. The processor 250 may output the first TTS audio signal at a first level of volume, output the counterpart's utterance at the second level of volume greater than the first level, and output the second TTS audio signal at the third level of volume greater than the second level.

When the processor 250 outputs the second TTS audio signal, the processor 250 may apply an image effect to the fourth text in synchronization with an output time of the second TTS audio signal. For example, when the fourth text is “How are you?” and the processor 250 outputs the second TTS audio signal for “How are you?”, an indicator for “How” in the fourth text may be displayed while “How” is being output, an indicator for “are” in the fourth text may be displayed while “are” is being output, and an indicator for “you” in the fourth text may be displayed while “you” is being output. For example, the indicator may include a change in color, font size, font weight, or typeface, an inversion effect, and/or an underscore.

The electronic device of the counterpart may output the first TTS audio signal. In an example, when the electronic device of the counterpart outputs the first TTS audio signal, the electronic device 200 of the user may also output the same first TTS audio signal in order to inform the user and the counterpart of an utterance time. The processor 250 may output the first TTS audio signal in synchronization with a time when the first TTS audio signal is output from the electronic device of the counterpart. In an example, while the electronic device of the counterpart outputs the first TTS audio signal, the electronic device 200 of the user may maintain a muted state. In an example, while the electronic device of the counterpart outputs the first TTS audio signal, the electronic device 200 of the user may output a beep sound. In an example, when the electronic device of the counterpart outputs the first TTS audio signal, the electronic device 200 of the user may output a beep sound at an output time point and an end time point of the first TTS audio signal of the electronic device of the counterpart.

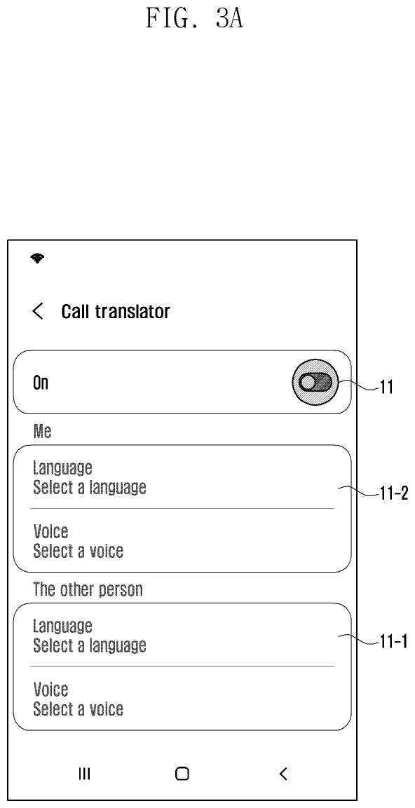

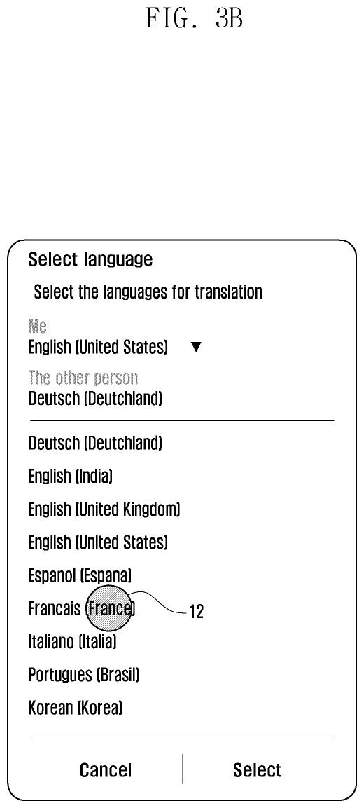

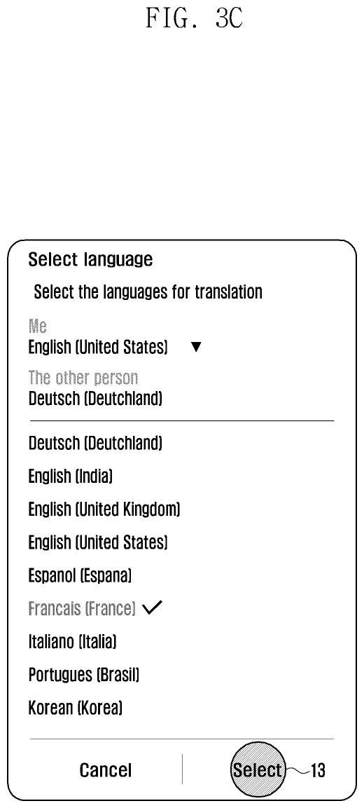

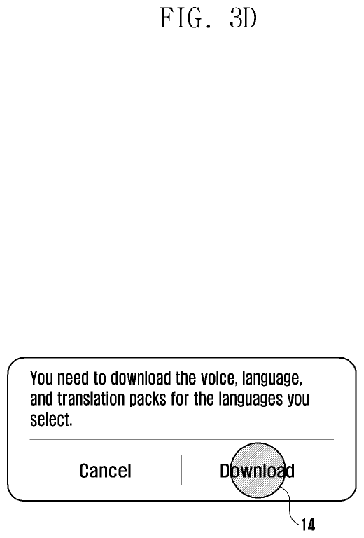

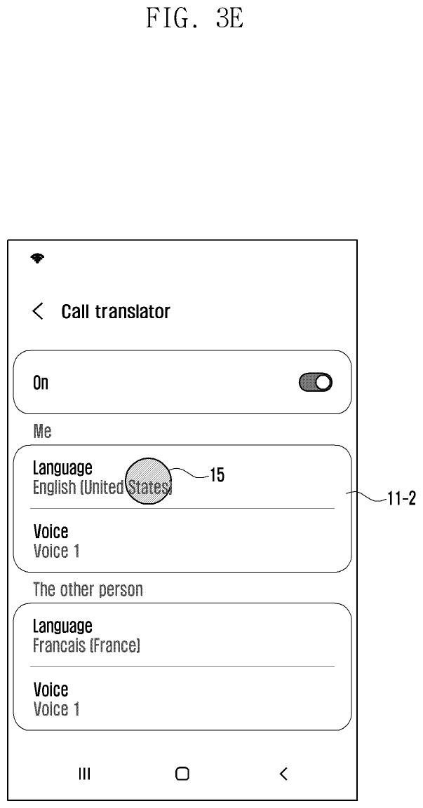

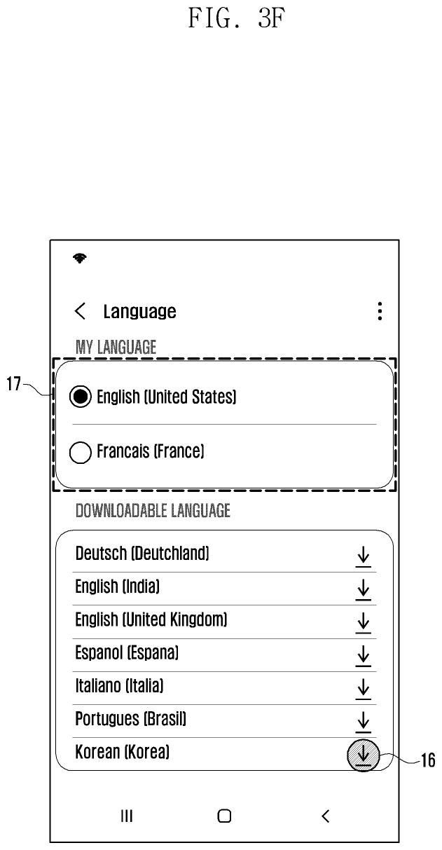

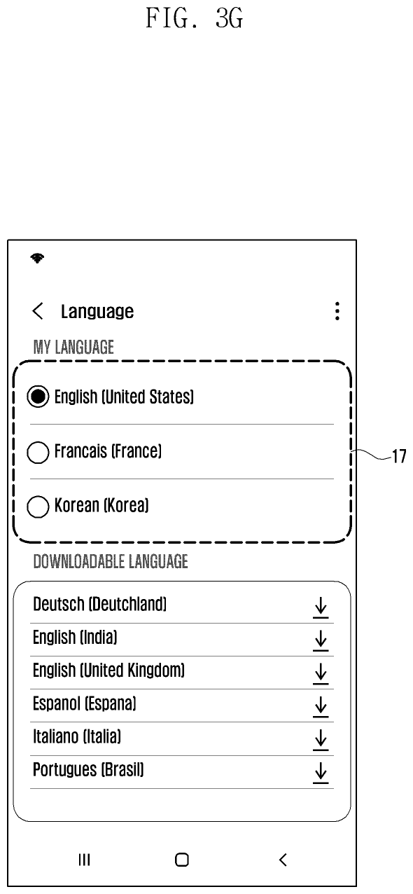

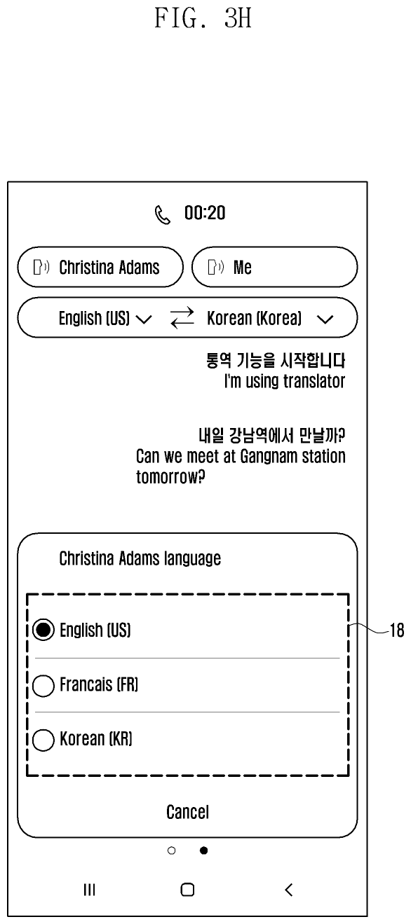

FIGS. 3A, 3B, 3C, 3D, 3E, 3F, 3G, and 3H are diagrams illustrating an operation of installing language data according to various embodiments of the disclosure. An electronic device 200 may download, store, and install user language data and/or counterpart language data before making a call with a counterpart. The electronic device 200 may configure one language as a default language according to a command of a user. When an interpretation function is selected while calling a counterpart whose language has not been configured, the electronic device 200 may perform the interpretation function using the configured default language.

Referring to FIG. 3A, in an example, the electronic device 200 may include an option of activating the interpretation function. When the interpretation function is enabled (11) (or activated), the electronic device 200 may convert the user's utterance into text, translate the user's utterance into a configured language of the counterpart to generate text, and convert the translated text of the user's utterance into a TTS audio signal. The electronic device 200 may transmit the user's utterance and/or the converted TTS audio signal to an electronic device of the counterpart. In addition, the electronic device 200 may convert a received utterance of the counterpart into text, translate the counterpart's utterance into the configured language of the user to generate text, and convert the translated text of the counterpart's utterance into a TTS audio signal. The electronic device 200 may output the counterpart's utterance and/or the converted TTS audio signal.

The electronic device 200 may configure various pieces of information or change configured information according to a command of the user before performing the interpretation function. For example, when the interpretation function is enabled (11), the electronic device 200 may activate interpretation-related configuration items 11-1 and 11-2. The interpretation-related configuration items 11-1 and 11-2 may include a configuration item 11-2 for the user and a configuration item 11-1 for the counterpart. For example, the item 11-2 for the user may include an item for configuring the user's language and/or a voice for a TTS audio signal output to the user. The item 11-1 for the counterpart may include an item for configuring the counterpart's language and/or a voice for a TTS audio signal output to the counterpart. In an example, the electronic device 200 may select the item 11-1 for the counterpart according to a command of the user.

Referring to FIG. 3B, in an example, a language list screen for selecting the counterpart's language is illustrated. For example, English may be configured as the user's language, and German may be configured as the counterpart's language. The electronic device 200 may configure (or change) the user's language and/or the counterpart's language according to a command of the user. For example, when a counterpart language configuration item is selected from the item 11-1 for the counterpart in FIG. 3A, the electronic device 200 may display a list of languages available for selection as the language of the counterpart as in FIG. 3B. One language may be chosen by the user from the displayed list of languages.

Referring to FIG. 3C, when the chosen language is selected, the electronic device 200 may change the counterpart's language from the currently configured language to the selected language. In an example, when French 12 is chosen from the displayed list of languages and French is selected (13), the electronic device 200 may determine whether language data for the selected language (e.g., French 12) is installed. Referring to FIG. 3D, in an example, the electronic device 200 may display a message related to download of language data. For example, when the language data is installed in the electronic device 200, the electronic device 200 may configure (or change) the selected language as the counterpart's language. When the language data is not installed in the electronic device 200, the electronic device 200 may display the message related to download 14 of language data as illustrated in FIG. 3D.

When Cancel is selected, the electronic device 200 may display a previous screen (e.g., FIG. 3C). When Download is selected, the electronic device 200 may download the language data for the selected language of the counterpart. For example, when French 12 is selected and the language data for French 12 is not installed in the electronic device 200, the electronic device 200 may download the language data for French 12 from a server.

In an example, as illustrated in FIG. 3E, when the electronic device 200 completes downloading (or installing) the language data, the electronic device 200 may display an interpretation function configuration screen. In an example, the electronic device 200 may change a counterpart language configuration to newly selected French 12.

The electronic device 200 may select a user language configuration (change) item 15 according to a command of the user. In an example, when the user language configuration item 15 is selected from the item 11-2 for the user according to the command of the user, the electronic device 200 may configure (or change) the language of the user in a manner similar to FIGS. 3A to 3E.

For example, when the user language configuration item 15 is selected, the electronic device 200 may display a list of languages available for selection as the language of the user. When one language is selected by the user from the displayed list of languages, the electronic device 200 may change the user's language from the currently configured language to the selected language. In an example, when English is selected from the displayed list of languages, the electronic device 200 may determine whether language data for the selected language (e.g., English) is installed. When the language data is installed in the electronic device 200, the electronic device 200 may configure (or change) the selected language as the user's language. When the language data is not installed in the electronic device 200, the electronic device 200 may display a message related to download of language data. When Download is selected, the electronic device 200 may download the language data for the selected language of the user. For example, when English is selected and the language data for English is not installed in the electronic device 200, the electronic device 200 may download the language data for English from the server. When completing downloading (or installing) the language data, the electronic device 200 may change a language configuration of the user to newly selected English.

Referring to FIG. 3F, as an example, a UI associated with a change of a user language is illustrated. The electronic device 200 may display a user language configuration area 17 including a configured user language and/or a selectable user language. Further, the electronic device 200 may display a list of languages for which language data is downloadable. For example, a downloadable language may be a language that may be added as a user language. For example, the user language configuration area 17 may include one or more languages for which language data is installed. In an example, as illustrated in FIG. 3F, when language data for English and French is installed in the electronic device 200, the user language configuration area 17 may include English and French. The electronic device 200 may configure (or change) a language selected by the user among the languages included in the user language configuration area 17 as the user's language. The list of downloadable languages may include one or more languages addable as the user's language. For example, the languages included in the language list may be languages for which language data is downloadable (or installable) from the server.

In an example, the electronic device 200 may select Korean 16 included in the list of languages addable according to a command of the user. Since Korean 16 is included in the list of addable languages, language data for Korean 16 may not be installed in the electronic device 200. The electronic device 200 may download the language data for Korean 16 from the server.

Referring to FIG. 3G, the electronic device 200 may include a language for which language data is downloaded in the user language configuration area 17. In an example, since the electronic device 200 has downloaded (or installed) the language data for Korean 16, the electronic device 200 may include Korean 16 in the user language configuration area 17. The electronic device 200 may configure English, French, or Korean included in the user language configuration area 17 as the user's language according to a command of the user.

Referring to FIG. 3H, in an example, the electronic device 200 may display a counterpart language configuration pop-up window 18 during a call according to a command of the user. The electronic device 200 may change the user's language and/or the counterpart's language during a call. In an example, when the electronic device 200 receives a counterpart language configuration change command from the user, the electronic device 200 may display the counterpart language configuration pop-up window 18. The counterpart language configuration pop-up window 18 may include a language of installed language data. The electronic device 200 may configure a language selected in the counterpart language configuration pop-up window 18 according to a command of the user as the counterpart's language. In an example, when a command to select French is received while the counterpart's language is configured to English, the electronic device 200 may change the counterpart's language from English to French. The electronic device 200 may switch translation of the user's utterance from English to French.

In an example, configuring (or changing) the counterpart language may also be performed through operations similar to those described with reference to FIGS. 3E to 3H.

For example, the electronic device 200 may select a counterpart language configuration (change) item on the interpretation function configuration screen according to a command of the user. The electronic device 200 may display a counterpart language configuration area including a configured counterpart language and/or a selectable counterpart language. Further, the electronic device 200 may display a list of languages addable as the counterpart's language. For example, the counterpart language configuration area may include one or more languages for which language data is installed. The electronic device 200 may configure (or change) a language selected by the user among the languages included in the counterpart language configuration area as the counterpart's language. The list of languages addable as the counterpart's language may include one or more addable languages. For example, the languages included in the language list may be languages for which language data is downloadable (or installable) from the server.

When language data for the selected language is not installed in the electronic device 200, the electronic device 200 may download the language data from the server. The electronic device 200 may include the language for which the language data is downloaded in the counterpart language configuration area. The electronic device 200 may configure the selected language among at least one language included in the counterpart language configuration area as the counterpart's language according to a command of the user.

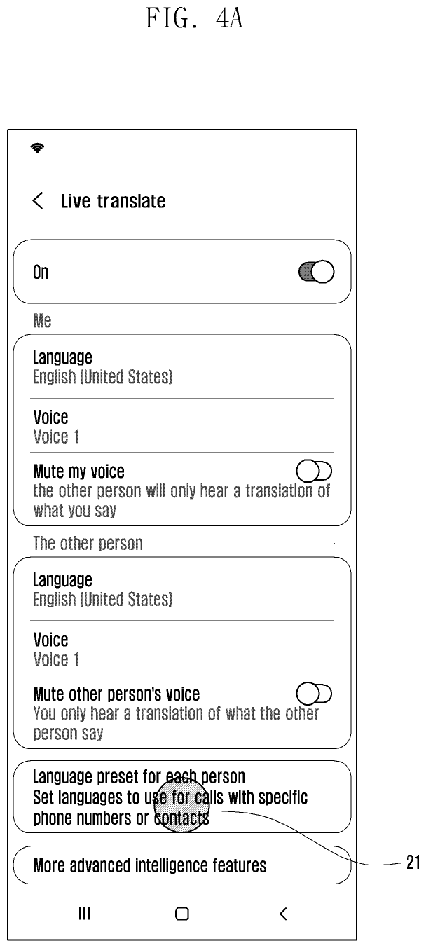

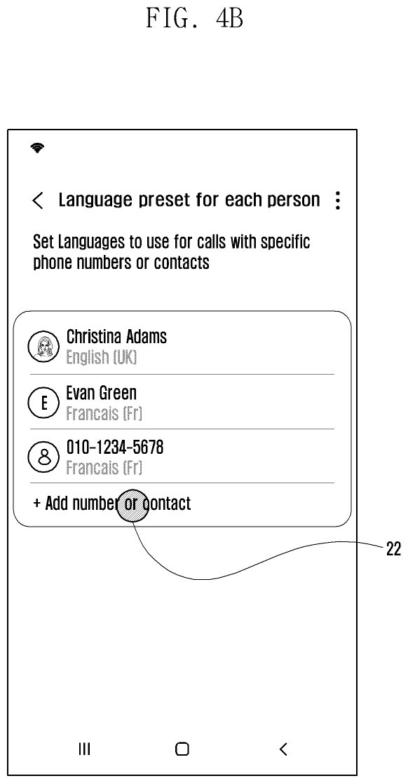

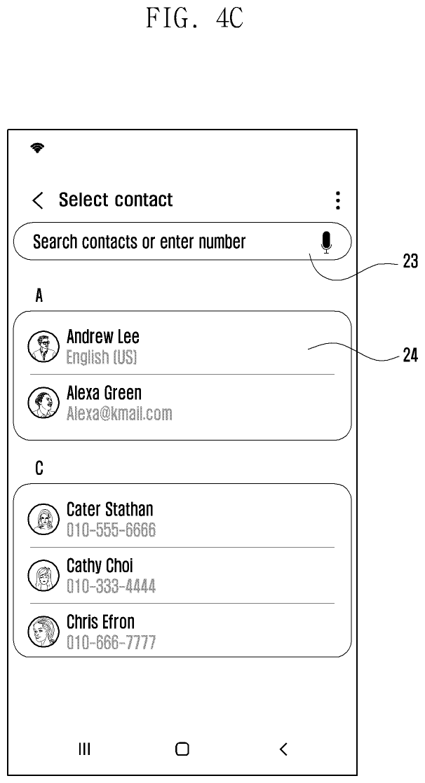

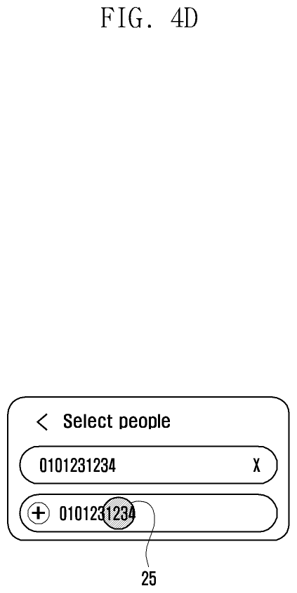

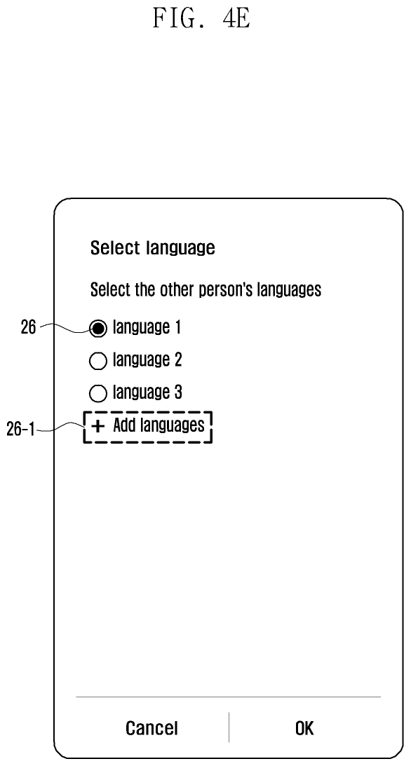

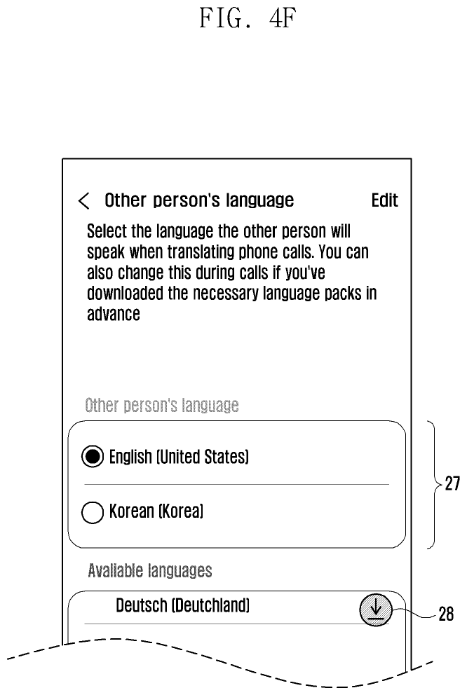

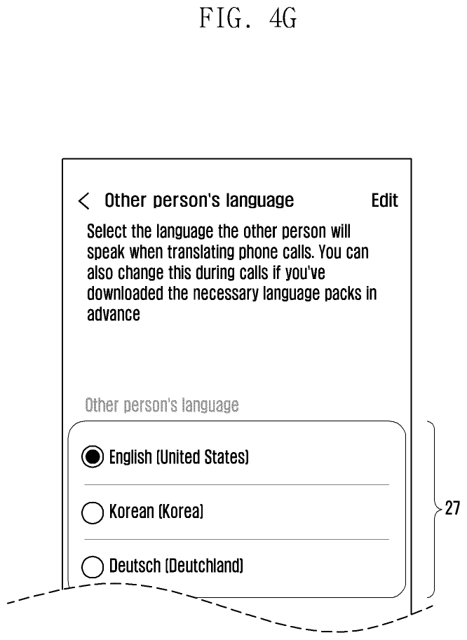

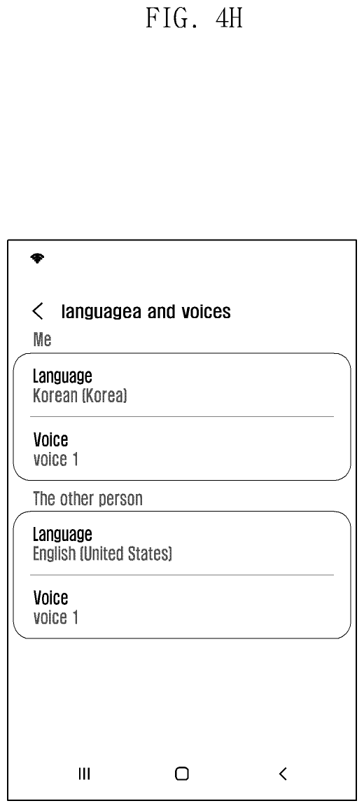

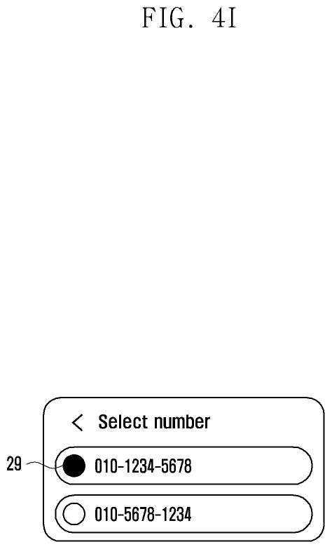

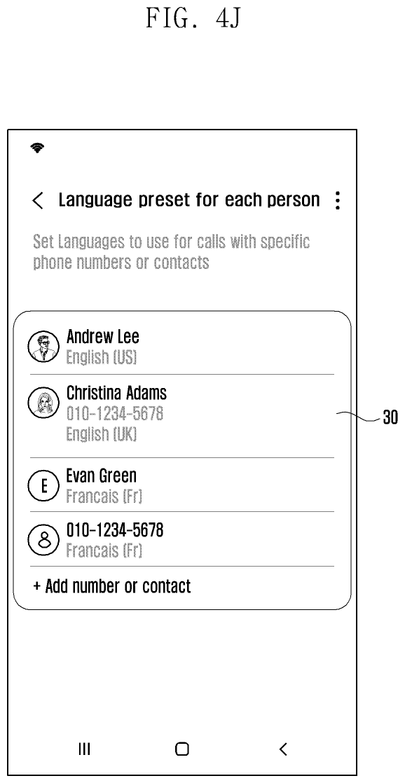

FIGS. 4A, 4B, 4C, 4D, 4E, 4F, 4G, 4H, 4I, and 4J are diagrams illustrating an operation of configuring a language of a counterpart according to various embodiments of the disclosure.

Referring to FIG. 4A, as an example, an interpretation function configuration screen is illustrated. The interpretation function configuration screen may include interpretation function on/off, a user language, a voice for a TTS audio signal output to a user, user utterance muting, a counterpart language, a voice for a TTS audio signal output from an electronic device of a counterpart, counterpart utterance muting, and/or an item 21 for configuring a language of each counterpart. For example, when a user utterance muting item is enabled, the electronic device 200 may transmit only a converted first TTS audio signal to the electronic device of the counterpart, without transmitting the user's utterance to the electronic device of the counterpart. When the user utterance muting item is disabled, the electronic device 200 may transmit the user's utterance and/or the converted first TTS audio signal to the electronic device of the counterpart. When a counterpart utterance muting item is enabled, the electronic device 200 may output only a converted second TTS audio signal, without outputting the counterpart's utterance. When the counterpart utterance muting item is disabled, the electronic device 200 may output the counterpart's utterance and/or the converted second TTS audio signal.

A counterpart language configuration item may be an item for configuring a default language of the counterpart, and the item 21 for configuring the language of each counterpart may be an item for configuring a specific language used by each counterpart. When the item 21 for configuring the language of each counterpart is selected, the electronic device 200 may configure a specific language for each user as a language of a specific counterpart.

Referring to FIG. 4B, in an example, when the counterpart language configuration option 21 is selected, the electronic device 200 may display a list (or interpretation list) of counterparts whose language is configured and/or a counterpart addition option 22. For example, a counterpart included in the list may be a counterpart for which a specific language is selected. When the user calls a counterpart included in a list, the electronic device 200 may interpret a call into a language configured for the counterpart included in the list. When the counterpart addition option 22 is selected, the electronic device 200 may perform an operation of adding a counterpart to the counterpart list and configuring the counterpart's language.

Referring to FIGS. 4C and 4D, in an example, when the counterpart addition option 22 is selected, the electronic device 200 may select a counterpart whose language is configured according to a command of the user. The electronic device 200 may display a number input window 23 and/or a stored contact list. In an example, as illustrated in FIG. 4C, the electronic device 200 may receive a selection of one contact from the displayed contact list, or as illustrated in FIG. 4D, the electronic device 200 may directly receive a direct input of a number 25 in the number input window 23. The electronic device 200 may determine whether the selected (or input) counterpart is a counterpart whose language has been already configured. When the selected (or input) counterpart is the counterpart whose language has been configured, the electronic device 200 may display a notification message for the user 24.

Referring to FIG. 4E, when a counterpart whose language is to be configured is selected, the electronic device 200 may display a configurable language list. The configurable language list may include one or more languages. For example, the languages included in the configurable language list may be languages for which language data has been installed. Further, the electronic device 200 may receive an input for selecting one language 26 from the user, or may receive an input for adding a new language 26-1.

Referring to FIG. 4F, in an example, the electronic device 200 may display a configurable language list 27 and an addable language list. The addable language list may include a language for which language data is not installed in the electronic device 200. When German 28 is selected from the addable language list by the user, the electronic device 200 may download language data for German 28 from a server. In addition, referring to FIG. 4G, the electronic device 200 may add German to the configurable language list 27.

Referring to FIG. 4H, in an example, the electronic device 200 may include a configuration menu for a language and a voice for a TTS audio signal. In an example, the electronic device 200 may display a language configured as a user language and a voice for outputting the first TTS audio signal in a user item (e.g., Me), and may display a language configured as a counterpart language and a voice for transmitting a second TTS audio signal in a counterpart item (e.g., Andrew Lee). When the language and/or the voice for the TTS audio signal included in the user item is selected, the electronic device 200 may change the user's language and/or the voice for the first TTS audio signal according to a command of the user. When the language and/or the voice for the TTS audio signal included in the counterpart item is selected, the electronic device 200 may change the counterpart's language and/or the voice for the second TTS audio signal according to a command of the user.

Referring to FIG. 4I, in an example, a plurality of numbers is displayed. When a plurality of numbers corresponds to a selected counterpart, the electronic device 200 may display the plurality of numbers corresponding to the selected counterpart. The electronic device 200 may select one number 29 among the plurality of numbers according to a command of the user. The electronic device 200 may configure a language and/or a voice corresponding to the selected one number 29 through the foregoing operations.

Referring to FIG. 4J, the electronic device 200 may display a list of counterparties whose language is configured. For example, the electronic device 200 may display a name or number of a counterpart, and display a configured language. In an example, when there is a plurality of numbers of counterparts, the electronic device 200 may display names of the counterparts, the numbers with configured languages, and the configured languages (30).

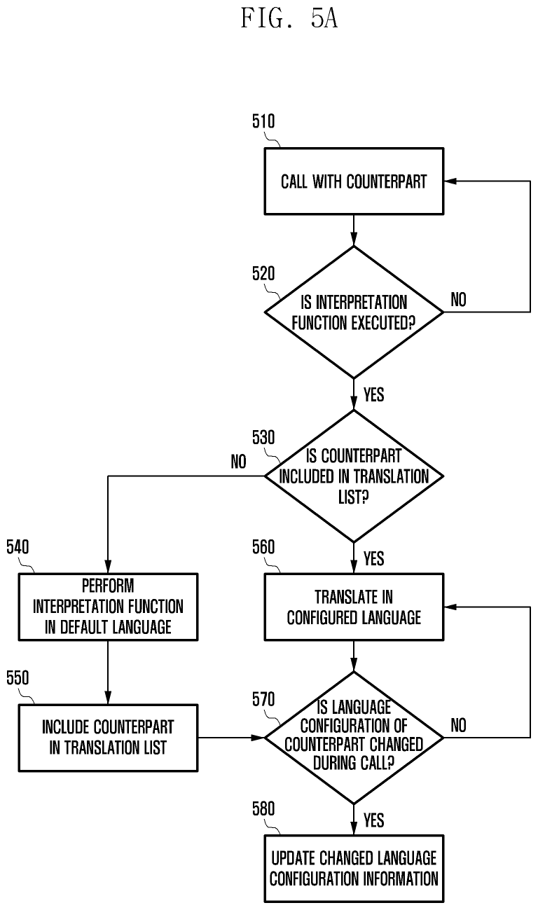

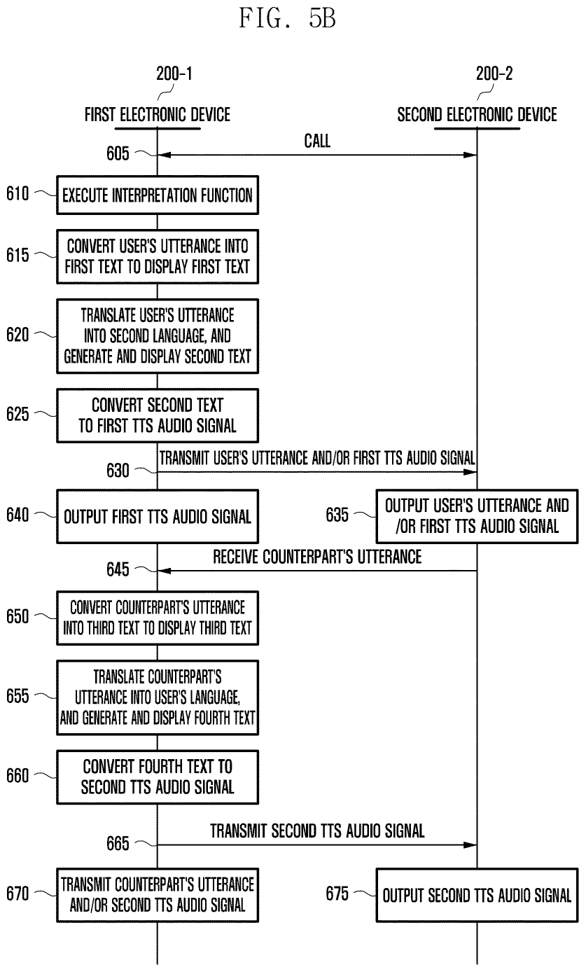

FIG. 5A is a flowchart illustrating an interpretation operation according to an embodiment of the disclosure.

In the following embodiments, operations may be sequentially performed but are not necessarily sequentially performed. For example, the order of the operations may be changed, and at least two operations may be performed in parallel.

According to an embodiment, operations 510 to 580 may be construed as being performed by a processor (e.g., the processor 250 of FIG. 2) of an electronic device (e.g., the electronic device 200 of FIG. 2).

Referring to FIG. 5A, the electronic device 200 may perform a call function with a counterpart at operation 510, and may determine whether an interpretation function is executed at operation 520. When the interpretation function is not executed (NO in 520), the electronic device 200 may perform a general call function at operation 510. When the interpretation function is executed (YES in 520), the electronic device 200 may determine whether the counterpart on the call is a counterpart included in an interpretation list at operation 530. The counterpart included in the interpretation list may be a counterpart whose language has been configured and for whom configured language data has been downloaded.

When the counterpart is not included in the interpretation list (NO in 530), the electronic device 200 may perform the interpretation function in a configured default language at operation 540. In addition, the electronic device 200 may add the counterpart on the call to the interpretation list at operation 550. When the counterpart is included in the interpretation list (YES in 530), the electronic device 200 may perform an interpretation function in the configured language at operation 560.

The electronic device 200 may determine whether the language configuration of the counterpart is changed during the call at operation 570. When the language configuration of the counterpart is not changed during the call (NO in 570), the electronic device 200 may perform the interpretation function in the previously configured language at operation 560. When the language configuration of the counterpart is changed during the call (YES in 570), the electronic device 200 may perform the interpretation function in a changed language. In addition, the electronic device 200 may update changed language configuration information at operation 580.

FIG. 5B is a timing diagram illustrating an interpretation operation according to an embodiment of the disclosure.

In the following embodiments, operations may be sequentially performed but are not necessarily sequentially performed. For example, the order of the operations may be changed, and at least two operations may be performed in parallel.

According to an embodiment, operations 605 to 675 may be construed as being performed by a processor (e.g., the processor 250 of FIG. 2) of an electronic device (e.g., the electronic device 200 of FIG. 2 and/or the electronic device 102 or 104 of FIG. 1).

Referring to FIG. 5B, a first electronic device 200-1 (e.g., an electronic device of a user) and a second electronic device 200-2 (e.g., an electronic device of a counterpart) may perform a call function at operation 605. During a call, the first electronic device 200-1 may execute an interpretation function according to a command of the user at operation 610.

The first electronic device 200-1 may convert an utterance of the user into first text, and may display the converted first text at operation 615. For example, the first electronic device 200-1 may convert the user's utterance into the first text by using an STT method. The first electronic device 200-1 may generate a conversation script, and may display sequentially generated text on the conversation script.

The first electronic device 200-1 may translate the user's utterance into a configured second language, and generate and display second text at operation 620. For example, the second language may be a language configured as a language of the counterpart. The first electronic device 200-1 may translate the user's utterance (or first text) to generate the second text. The first electronic device 200-1 may display the generated second text in an area adjacent to the displayed first text.

In an example, the user's language (e.g., a first language) may be configured to Korean, and the counterpart's language (e.g., a second language) may be configured to English. When the user utters “Annyeonghaseyo” in Korean,” the first electronic device 200-1 may convert the user's utterance into first text and display the first text on a conversation script. The first electronic device 200-1 may translate the user's utterance (or first text) into English. In an example, the first electronic device 200-1 may generate second text by translating “Annyeonghaseyo” into “Hello.” Further, the first electronic device 200-1 may display “Hello” in an area adjacent to “Annyeonghaseyo” displayed on the conversation script.

The first electronic device 200-1 may convert the second text to a first TTS audio signal at operation 625, and may transmit the user's utterance and/or the first TTS audio signal at operation 630. For example, the first electronic device 200-1 may include a mute option for the user's utterance. When the mute option for the user's utterance is enabled, the first electronic device 200-1 may transmit only the converted first TTS audio signal to the second electronic device 200-2, without transmitting the user's utterance. When the mute option for the user's utterance is disabled, the first electronic device 200-1 may transmit the user's utterance and the converted first TTS audio signal to the second electronic device 200-2.

The second electronic device 200-2 may output the received user's utterance and/or first TTS audio signal at operation 635. In an example, when the user speaks, the second electronic device 200-2 may receive the user's utterance from the first electronic device 200-1 and output the same. When the first TTS audio signal is generated in the first electronic device 200-1, the second electronic device 200-2 may receive the first TTS audio signal from the first electronic device 200-1 and output the same. In an example, the second electronic device 200-2 may simultaneously receive the user's utterance and the first TTS audio signal from the first electronic device 200-1, and may sequentially output the received user's utterance and first TTS audio signal. For example, the second electronic device 200-2 may output the user's utterance at a fifth level of volume, and may output the first TTS audio signal at a sixth level of volume, which is greater than the fifth level. The second electronic device 200-2 may receive an input of the counterpart's utterance. In an example, the second electronic device 200-2 may output a second TTS audio signal in operation 675 described below. The second electronic device 200-2 may output the second TTS audio signal at a fourth level of volume smaller than the fifth level.

In an example, when the second electronic device 200-2 outputs the first TTS audio signal, the first electronic device 200-1 may also output the same first TTS audio signal to inform the user and the counterpart of an utterance time at operation 640. The first electronic device 200-1 may output the first TTS audio signal in synchronization with a time when the first TTS audio signal is output from the second electronic device 200-2. In an example, the first TTS audio signal transmitted to the second electronic device 200-2 may include time information. For example, the time information may include information about current time and delay time or information about an output time point. The first electronic device 200-1 and the second electronic device 200-2 may output the first TTS audio signal in synchronization, based on the time information included in the first TTS audio signal. For example, the first electronic device 200-1 and the second electronic device 200-2 may not perform a separate synchronization process. The first electronic device 200-1 may transmit the first TTS audio signal to the second electronic device 200-2 and then output the same, and the second electronic device 200-2 may output the first TTS audio signal immediately upon receiving the same. For example, while the second electronic device 200-2 outputs the first TTS audio signal, the first electronic device 200-1 may maintain a muted state. In an example, while the second electronic device 200-2 outputs the first TTS audio signal, the first electronic device 200-1 may output a beep sound. In an example, when the second electronic device 200-2 outputs the first TTS audio signal, the first electronic device 200-1 may output a beep sound at an output time point and an end time point of the first TTS audio signal of the second electronic device 200-2.

The first electronic device 200-1 may receive an utterance of the counterpart from the second electronic device 102 at operation 645, and may convert the received counterpart's utterance into third text to display the third text at operation 650. In an example, the first electronic device 200-1 may receive the counterpart's utterance, “I go to the fish market,” from the second electronic device 200-2. The first electronic device 200-1 may convert the counterpart's utterance into text, and may display “I go to the fish market” on the conversation script.

The first electronic device 200-1 may translate the counterpart's utterance (or third text) into a language of the user, and generate and display fourth text at operation 655. The first electronic device 200-1 may translate the counterpart's utterance (or third text) to generate the fourth text. The first electronic device 200-1 may display the generated fourth text in an area adjacent to the displayed third text. In an example, the first electronic device 200-1 may translate the counterpart's utterance (or third text) into Korean. The first electronic device 200-1 may generate the fourth text by translating “I go to the fish market” into “Naneun susan sijange ga.” Further, the first electronic device 200-1 may display “Naneun susan sijange ga” in an area adjacent to “I go to the fish market” displayed on the conversation script.

The first electronic device 200-1 may convert the fourth text into a second TTS audio signal at operation 660. The first electronic device 200-1 may transmit the second TTS audio signal obtained by translating the counterpart's utterance (or third text) to the second electronic device 200-2 at operation 665, and the second electronic device 200-2 may output the received second TTS audio signal at operation 675. For example, the first electronic device 200-1 may output the received counterpart's utterance and/or the second TTS audio signal at operation 670.

In an example, when the counterpart speaks, the first electronic device 200-1 may receive the counterpart's utterance from the second electronic device 200-2 and output the same. When the second TTS audio signal is generated, the first electronic device 200-1 may output the second TTS audio signal in synchronization with the second TTS audio signal output by the second electronic device 200-2. In other words, when the second electronic device 200-2 outputs the second TTS audio signal, the first electronic device 200-1 may also output the second TTS audio signal. For example, the second TTS audio signal transmitted to the first electronic device 200-1 may include time information. For example, the time information may include information about current time and delay time or information about an output time point. The first electronic device 200-1 and the second electronic device 200-2 may output the second TTS audio signal in synchronization, based on the time information included in the second TTS audio signal. In an example, the first electronic device 200-1 and the second electronic device 200-2 may not perform a separate synchronization process. The second electronic device 200-2 may transmit the second TTS audio signal to the first electronic device 200-1 and then output the same, and the first electronic device 200-1 may output the second TTS audio signal immediately upon receiving the same.

In an example, the first electronic device 200-1 may record the counterpart's utterance, and may sequentially output the counterpart's utterance and the second TTS audio signal when the second electronic device 200-2 outputs the second TTS audio signal. For example, the first electronic device 200-1 may output the counterpart's utterance at a second level of volume, and may output the second TTS audio signal at a third level of volume, which is greater than the second level. In an example, the first electronic device 200-1 may output the first TTS audio signal in operation 640. The first electronic device 200-1 may output the first TTS audio signal at a first level of volume smaller than the second level of volume.

For example, the first electronic device 200-1 may include a mute option for the counterpart's utterance. When the mute option for the counterpart's utterance is enabled, the first electronic device 200-1 may output only the converted second TTS audio signal, without outputting the counterpart's utterance. When the mute option for the counterpart's utterance is disabled, the first electronic device 200-1 may output the counterpart's utterance and/or the converted second TTS audio signal.

In an example, the first electronic device 200-1 may output the received counterpart's utterance and/or the second TTS audio signal, without transmitting the second TTS audio signal to the second electronic device 200-2 at operation 670.

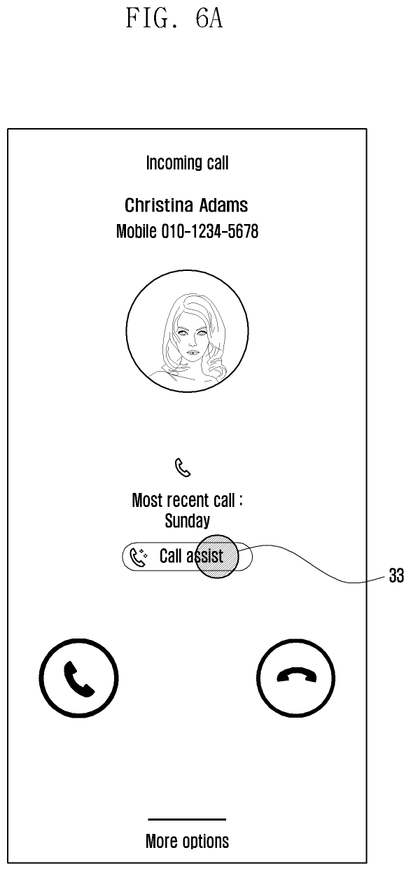

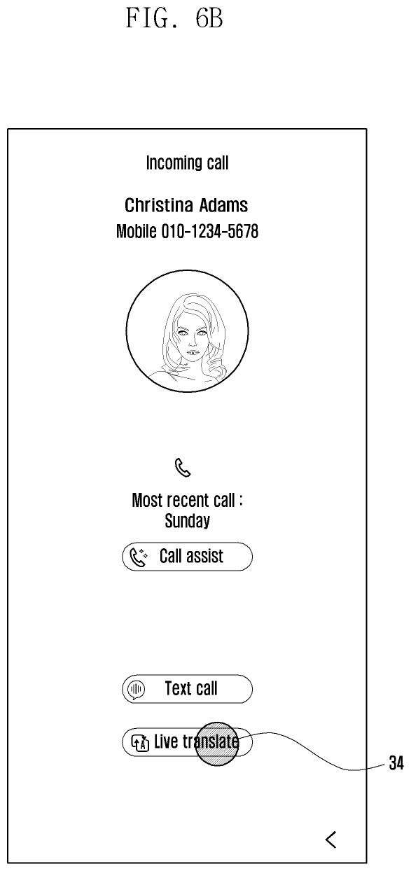

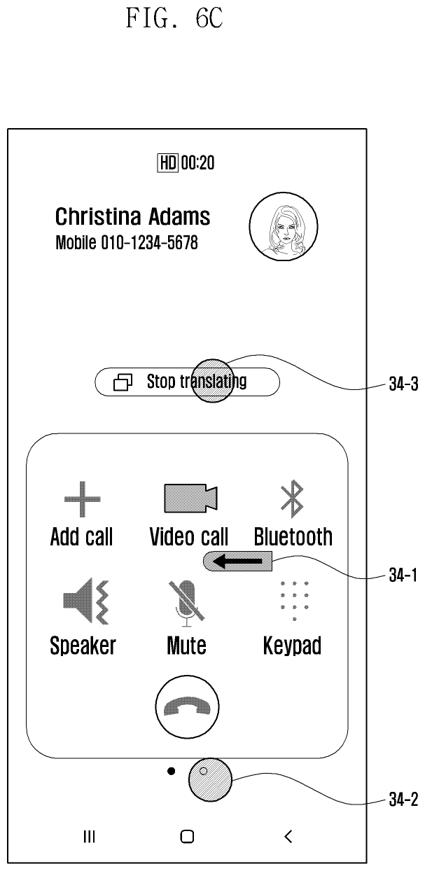

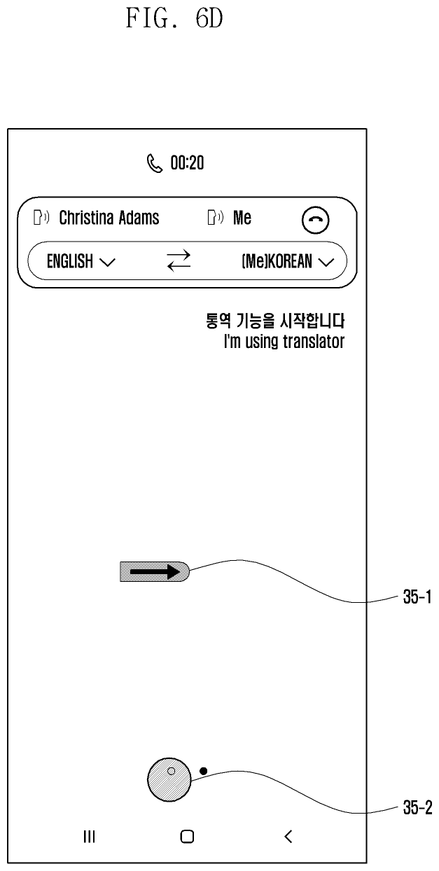

FIGS. 6A, 6B, 6C, and 6D are diagrams illustrating an operation of executing an interpretation function during an outgoing call according to various embodiments of the disclosure.

Referring to FIG. 6A, in an example, an outgoing call UI is illustrated. The outgoing call UI may include a call assist item 33. For example, the call assist item 33 may be an item for selecting an additional function during a call, and may include an on/off function for an interpretation function.

Referring to FIG. 6B, in an example, an electronic device 200 may display a text call item and a live translate item 34 according to selection of the call assist item 33. For example, the live translate item 34 may include the on/off function for the interpretation function. When the live translate item 34 is selected, the electronic device 200 may perform the interpretation function.

Referring to FIGS. 6C and 6D, a UI of the interpretation function is illustrated. The electronic device 200 may generate a conversation script screen separate from an outgoing call UI screen. For example, FIG. 6C illustrates an outgoing call UI screen with the interpretation function enabled. The electronic device 200 may display a stop translating item 34-3. When the stop translating item 34-3 is selected, the electronic device 200 may stop interpretation. Upon receiving a gesture 34-1 for switching a screen or an input 34-2 for selecting a different screen, the electronic device 200 may switch to the conversation script screen.

For example, FIG. 6D illustrates a conversation script screen. The conversation script screen may include information about a counterpart and information about a configured language of the counterpart and/or a configured language of a user. The electronic device 200 may display first text obtained by converting the user's utterance into text, second text generated by translating the user's utterance, third text obtained by converting the counterpart's utterance into text, and/or fourth text generated by translating the counterpart's utterance on the conversation script screen. The electronic device 200 may switch to the outgoing call UI screen when receiving a gesture 35-1 for switching a screen or an input 35-2 for selecting a different screen.

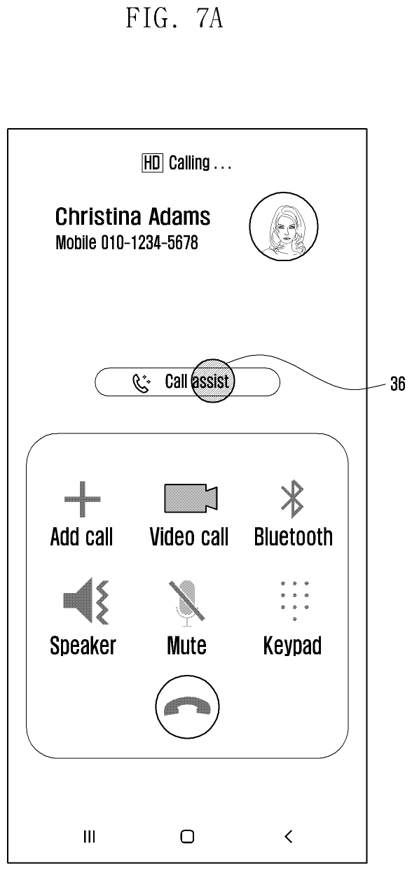

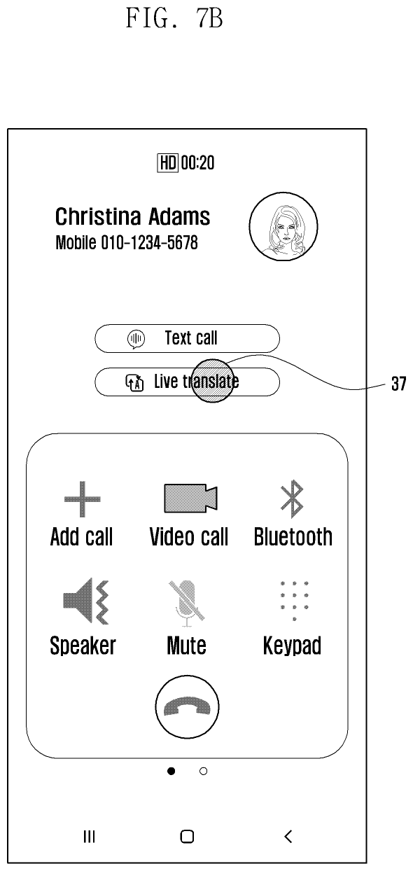

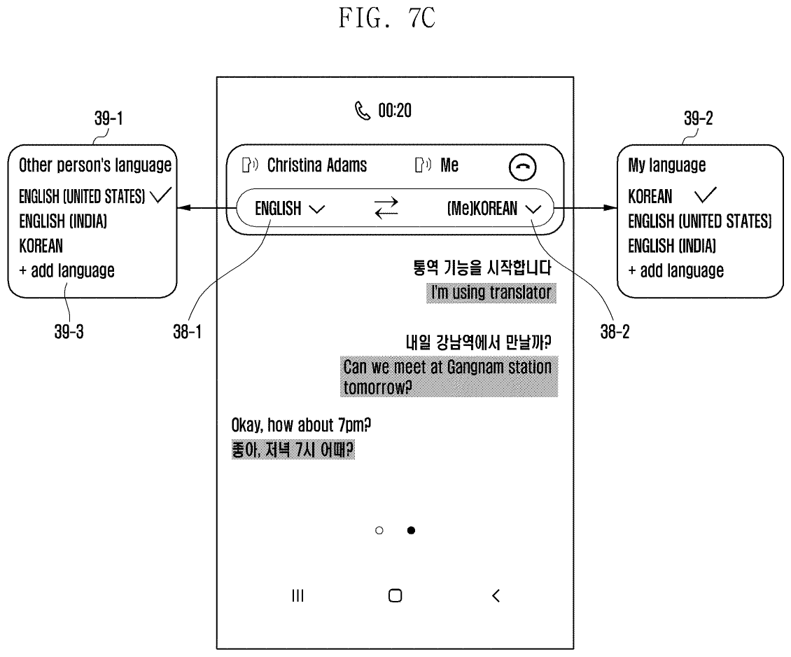

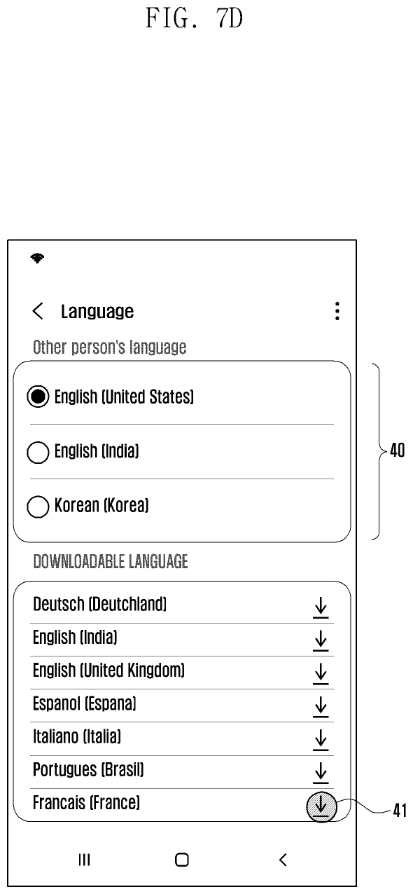

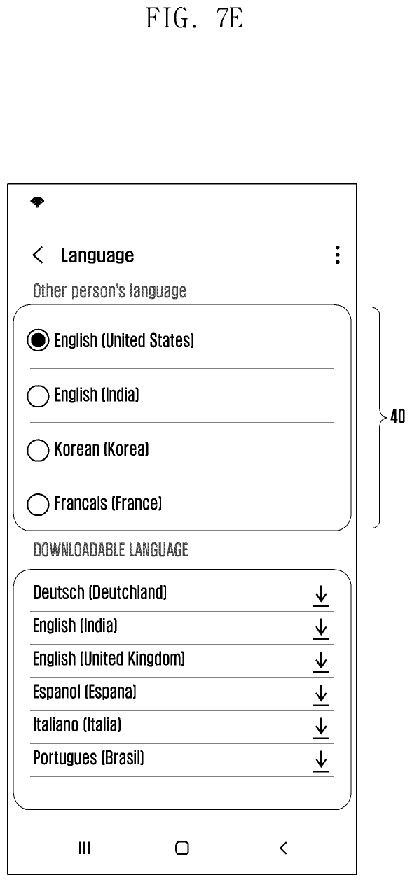

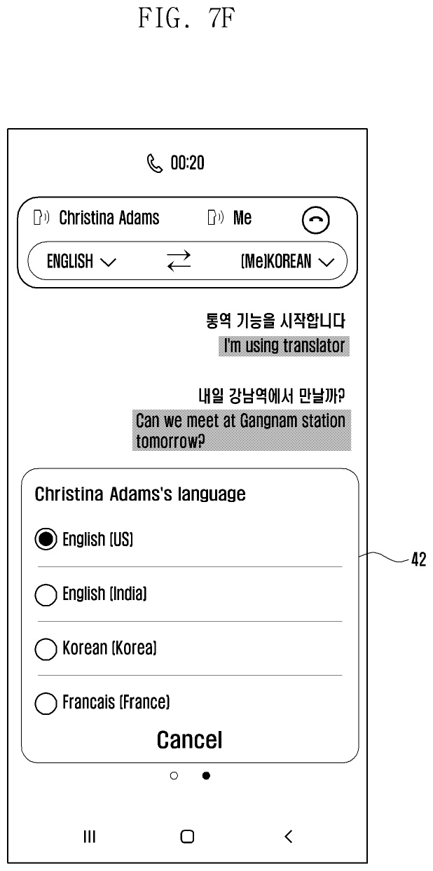

FIGS. 7A, 7B, 7C, 7D, 7E, and 7F are diagrams illustrating an operation of executing an interpretation function during an incoming call according to various embodiments of the disclosure.

Referring to FIG. 7A, in an example, an incoming call UI is illustrated. The incoming call UI may include a call assist item 36. For example, the call assist item 36 may be an item for selecting an additional function during a call, and may include an on/off function for an interpretation function.

Referring to FIG. 7B, in an example, an electronic device 200 may display a text call item and a live translate item 37 according to selection of the call assist item 36. For example, the live translate item 37 may include the on/off function for the interpretation function. When the live translate item 37 is selected, the electronic device 200 may turn on the interpretation function and receive a call.

Referring to FIG. 7C, in an example, a conversation script screen is illustrated. For example, the conversation script screen may include information about a counterpart and information about a configured language of the counterpart and/or a configured language of a user. The electronic device 200 may display first text obtained by converting the user's utterance into text, second text generated by translating the user's utterance, third text obtained by converting the counterpart's utterance into text, and/or fourth text generated by translating the counterpart's utterance on the conversation script screen.

For example, when the user's language 38-2 is selected, the electronic device 200 may display a menu for changing the language of the user. The electronic device 200 may display a menu 39-2 for selecting one of languages for which language data is installed. When a different language is selected according to a command of the user, the electronic device 200 may change the language of the user from the currently configured language (e.g., Korean) to the selected language (e.g., English (India)).

For example, when the language of the counterpart 38-1 is selected, the electronic device 200 may display a menu for changing the language of the counterpart. The electronic device 200 may display a menu 39-1 for selecting one of languages for which language data is installed. When a different language is selected according to a command of the user, the electronic device 200 may change the language of the counterpart from the currently configured language (e.g., English) to the selected language (e.g., Korean). In an example, when an add language item 39-3 is selected, the electronic device 200 may add a new language during the call.

Referring to FIG. 7D, in an example, a configuration screen in a case where the add language 39-3 is selected is illustrated. The configuration screen may include a selectable language area 40 and an addable language list. For example, the selectable language area 40 may include English (United States), English (India), and Korean. The electronic device 200 may select French 41 as a language to be added according to a command of the user. When French is selected, the electronic device 200 may receive language data for French 41 from a server. The electronic device 200 may receive, store, and install the language data for French 41.

Referring to FIG. 7E, in an example, a configuration screen in a case where French is installed is illustrated. For example, since French 41 has been installed, the selectable language area 40 may include English (United States), English (India), Korean, and French.

Referring to FIG. 7F, in an example, when the language of the counterpart 38-1 is selected, the electronic device 200 may display a counterpart language configuration menu as a pop-up window 42. The pop-up window 42 may include a language of installed language data. For example, since French 41 has been installed, the electronic device 200 may display English (US), English (India), Korean, and French in the pop-up window 42. The electronic device 200 may configure a language selected in the pop-up window 42 according to a command of the user as the language of the counterpart. In an example, when French is selected while the language of the counterpart is configured to English, the electronic device 200 may change the language of the counterpart from English to French. In addition, the electronic device 200 may switch translation of the user's utterance from English to French.

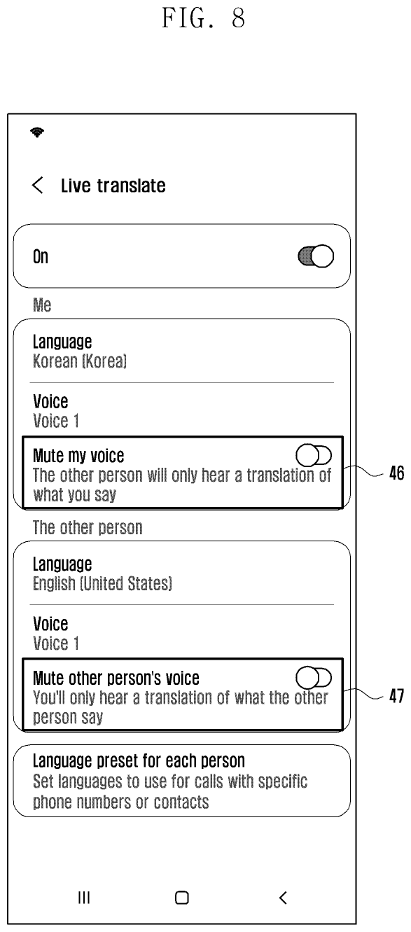

FIG. 8 is a diagram illustrating an utterance option according to an embodiment of the disclosure.

Referring to FIG. 8, an interpretation function configuration menu may include a mute option 46 for an utterance of a user and/or a mute option 47 for an utterance of a counterpart. For example, when the mute option 46 for the user's utterance is enabled, an electronic device 200 may transmit only a first TTS audio signal converted from the user's utterance to an electronic device of the counterpart, without transmitting the user's utterance to the electronic device of the counterpart. When the mute option for the user's utterance is disabled, the electronic device 200 may transmit the user's utterance and/or the first TTS audio signal converted from the user's utterance to the electronic device of the counterpart. For example, when the mute option 47 for the counterpart's utterance is enabled, the electronic device 200 may output only a second TTS audio signal converted from the counterpart's utterance, without outputting the counterpart's utterance. When the mute option 47 for the counterpart's utterance is disabled, the electronic device 200 may output the counterpart's utterance and/or the second TTS audio signal converted from the counterpart's utterance.

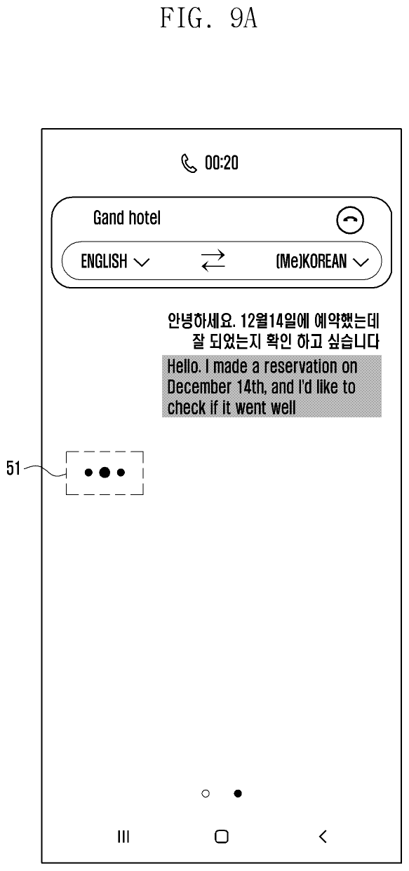

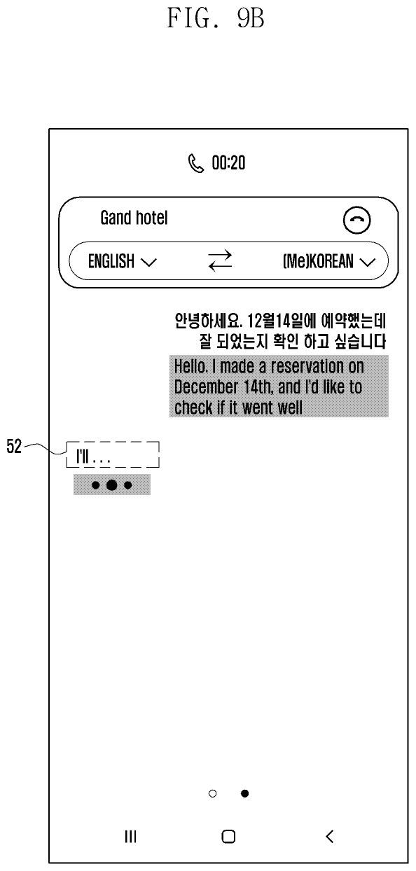

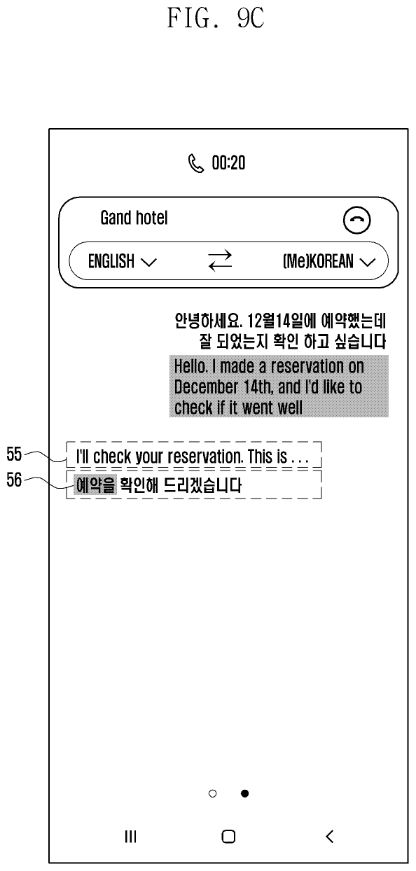

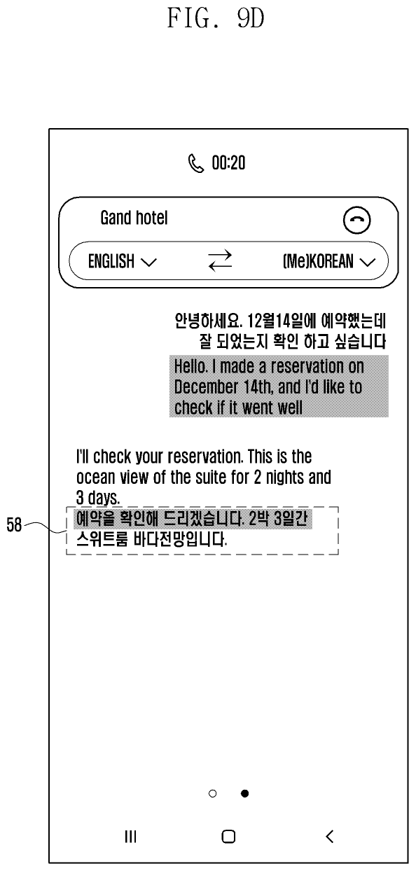

FIGS. 9A, 9B, 9C, and 9D are diagrams illustrating an interpretation operation displayed on a conversation script according to various embodiments of the disclosure.

Referring to FIG. 9A, for example, when a counterpart speaks, an electronic device 200 may display visual information 51 indicating that an utterance is being recognized on a conversation script. The electronic device 200 may recognize the utterance, convert the utterance into text, and display the text on the conversation script.

Referring to FIG. 9B, the electronic device 200 may partially recognize the utterance and convert the recognized utterance into text. The electronic device 200 may display the converted text 52 on the conversation script. The electronic device 200 may identify whether the counterpart has stopped speaking at predetermined time intervals. In an example, the electronic device 200 may identify whether the counterpart has stopped speaking at intervals of about 1500 ms. When the counterpart's utterance is stopped, the electronic device 200 may convert the utterance into text in certain units. For example, the electronic device 200 may convert the utterance into text in word units and display the text on the conversation script.

Referring to FIG. 9C, the electronic device 200 may display text generated by translating the counterpart's utterance. The electronic device 200 may display text 56 obtained by translating the counterpart's utterance or text 55 converted from the counterpart's utterance into a language of the user. For example, the electronic device 200 may identify a first sentence of the counterpart's utterance. The electronic device 200 may translate the identified first sentence into the language of the user. The electronic device 200 may display the text 56 of the translated first sentence.

For example, the electronic device 200 may transmit a second TTS audio signal to an electronic device of the counterpart. The second TTS audio signal may be an audio signal including the same content as the translated text 56 in the user's language. The electronic device of the counterpart may output the received second TTS audio signal. In an example, the second electronic device 102 may output the second TTS audio signal at a volume smaller than an output volume for the user's utterance.

Referring to FIG. 9D, the electronic device 200 may display text generated by translating a second sentence of the counterpart's utterance. For example, the electronic device 200 may identify the second sentence following the identified first sentence. The electronic device 200 may translate the identified second sentence into the user's language. The electronic device 200 may display text 58 including the second sentence after the translated first sentence. In other words, the electronic device 200 may identify and translate the user's utterance in sentence units. The electronic device 200 may display text translated in sentence units.

In addition, the electronic device 200 may convert the translated text 58 i the user's language into a TTS audio signal and output the TTS audio signal. The TTS audio signal may also be converted and output in sentence units. When outputting the TTS audio signal, the electronic device 200 may apply an image effect to the translated text 58 in the user's language in synchronization with a time when the TTS audio signal is output.

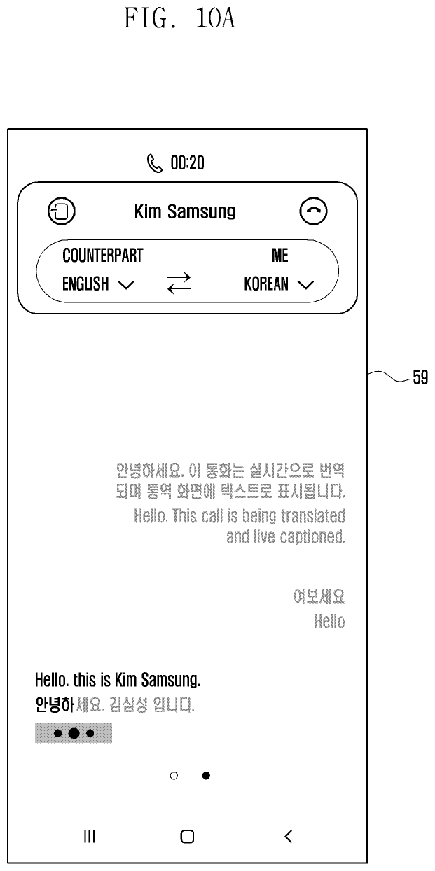

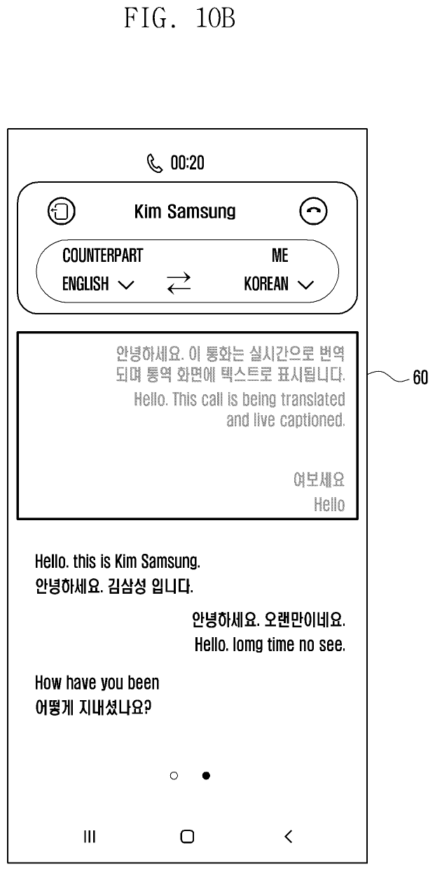

FIGS. 10A and 10B are diagrams illustrating a conversation script displaying an utterance and a translation according to various embodiments of the disclosure.

Referring to FIG. 10A, a conversation script 59 where interpretation starts is illustrated. In an example, an electronic device 200 may display text from the bottom of the conversation script 59. When next text is input (or generated), the electronic device 200 may shift currently displayed text up and display input next text at the bottom.

Referring to FIG. 10B, the electronic device 200 may delete text related to a previous utterance. In an example, the electronic device 200 may delete text 60 related to a previous utterance after a preset time has elapsed. In an example, when text exceeds a display limit of the conversation script, the electronic device 200 may delete the text 60 related to the previous utterance, which has been displayed first, among the text displayed on the conversation script, and may display new text. For example, the text 60 related to the previous utterance may be deleted from a screen and/or memory 210. In an example, the electronic device 200 may delete the text by gradually making the text disappear (e.g., fade out) over a predetermined time.

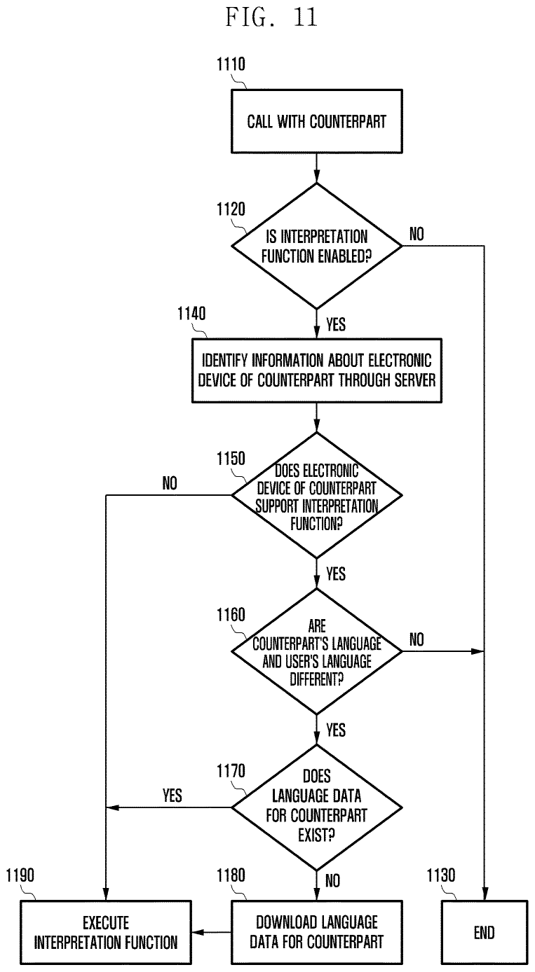

FIG. 11 is a flowchart illustrating an operation of performing an interpretation function, based on information about a counterpart identified through a server according to an embodiment of the disclosure.

In the following embodiments, operations may be sequentially performed but are not necessarily sequentially performed. For example, the order of the operations may be changed, and at least two operations may be performed in parallel.

According to an embodiment, operations 1110 to 1190 may be construed as being performed by a processor (e.g., the processor 250 of FIG. 2) of an electronic device (e.g., the electronic device 200 of FIG. 2).

Referring to FIG. 11, the electronic device 200 may perform a call function with a counterpart at operation 1110, and may determine whether an interpretation function is enabled (or activated) at operation 1120. When the interpretation function is not enabled (NO in 1120), the electronic device 200 may terminate an operation related to the interpretation function (or perform no particular operation) at operation 1130.

When the interpretation function is enabled (YES in 1120), the electronic device 200 may identify information about an electronic device of the counterpart through the server at operation 1140. For example, the information about the electronic device of the counterpart may include a country code and an area code of a number of the counterpart, system language information about the electronic device of the counterpart, a manufacturer of the electronic device of the counterpart, a model name of the electronic device of the counterpart, and/or interpretation function support information about the electronic device of the counterpart.

The electronic device 200 may determine whether the electronic device of the counterpart supports the interpretation function, based on the identified information about the electronic device of the counterpart at operation 1150. When the electronic device of the counterpart does not support the interpretation function (NO in 1150), the electronic device 200 may perform the interpretation function alone at operation 1190.

When the electronic device of the counterpart supports the interpretation function (YES in 1150), the electronic device 200 may determine whether a language of the counterpart and a language of a user are different at operation 1160. When the language of the counterpart and the language of the user are the same (NO in 1160), the operation related to the interpretation function may be terminated (or no particular operation may be performed) at operation 1130. For example, since the user and the counterpart use the same language, the electronic device 200 may not perform the interpretation function.

When the language of the counterpart and the language of the user are different (YES in 1160), the electronic device 200 may determine whether language data for the counterpart exists (or is installed) at operation 1170. When the language data for the counterpart exists (or installed) in the electronic device 200 (YES in 1170), the electronic device 200 may execute the interpretation function at operation 1190. The electronic device 200 may generate text by translating the user's utterance into the language of the counterpart, based on the determined language of the counterpart, and may transmit a TTS audio signal generated from the user's utterance and/or the translated text to the counterpart. In addition, the electronic device 200 may generate text by translating the counterpart's utterance into the language of the user, based on the configured language of the user, and may output a TTS audio signal generated from the counterpart's utterance and/or the translated text. The electronic device 200 may add the counterpart to an interpretation list.

When there is no language data for the counterpart (NO in 1170), the electronic device 200 may download language data for the counterpart at operation 1180. When the language data is downloaded, the electronic device 200 may store and install the language data, and may execute the interpretation function at operation 1190.

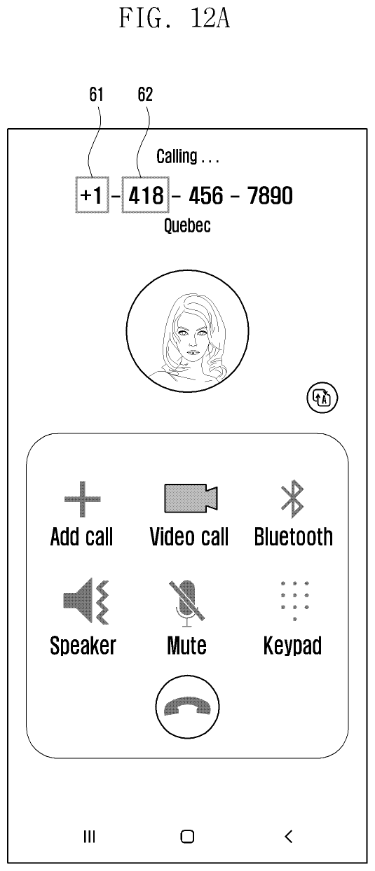

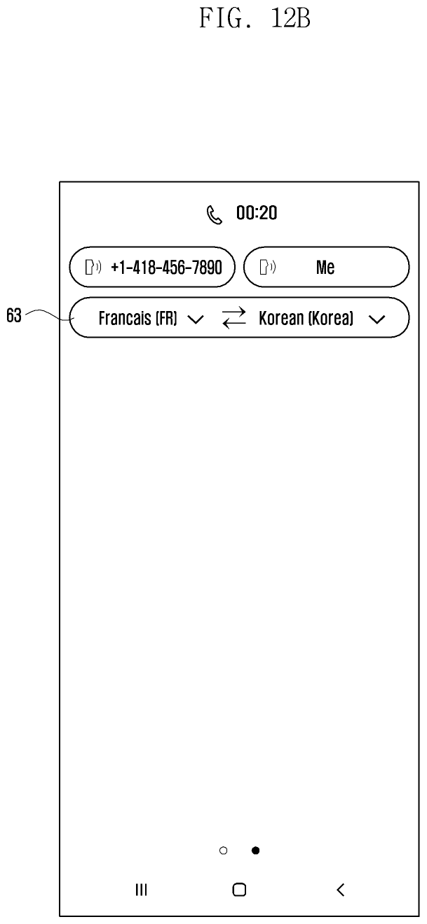

FIGS. 12A and 12B are diagrams illustrating an operation of configuring a language of a counterpart, based on number information about the counterpart according to various embodiments of the disclosure.

Referring to FIG. 12A, a received phone number of a counterpart may include a country code 61 and/or an area code 62. An electronic device 200 may configure a language of the counterpart, based on the country code 61 and/or the area code 62. In an example, when the country code is 1 and the area code is 418, the electronic device 200 may determine that the location of the counterpart is the Quebec region in Canada. The Quebec region in Canada may be a region where French is used. The electronic device 200 may configure the language of the counterpart to French, based on the determined location-based used language. When French is not installed in the electronic device 200, the electronic device 200 may download and install French language data through a server. In addition, the electronic device 200 may configure the language of the counterpart to French.

Referring to FIG. 12B, the electronic device 200 may execute the interpretation function, based on the configured user's language and counterpart's language. For example, the electronic device 200 may display a conversation script. The conversation script may include the number of the counterpart and information related to the configured counterpart's language and/or the configured user's language. In an example, since the electronic device 200 has determined that the language of the counterpart is French, the electronic device 200 may display French 63 as the information related to the counterpart's language.

The electronic device 200 may convert the user's utterance into first text, and may translate the user's utterance (or first text) into the language of the counterpart to generate second text. In an example, the first text may be Korean text, and the second text may be French text. The electronic device 200 may display the first text and/or the second text on the conversation script. The electronic device 200 may receive the counterpart's utterance. The electronic device 200 may convert the counterpart's utterance into third text, and may translate the counterpart's utterance (or third text) into the language of the user to generate fourth text. In an example, the third text may be French text, and the fourth text may be Korean text. The electronic device 200 may display the third text and/or the fourth text on the conversation script.

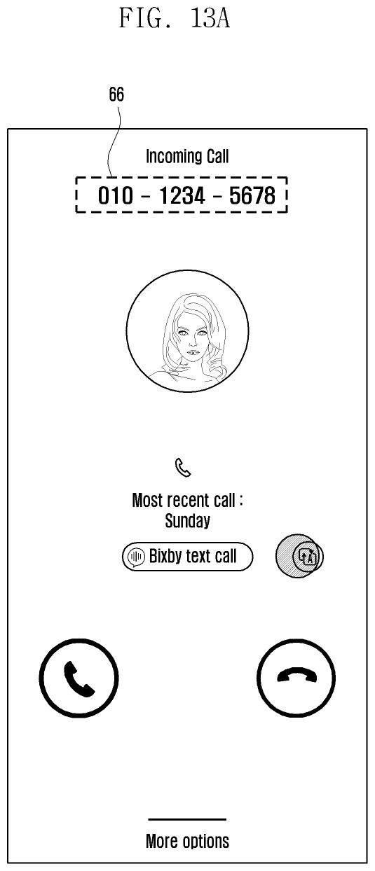

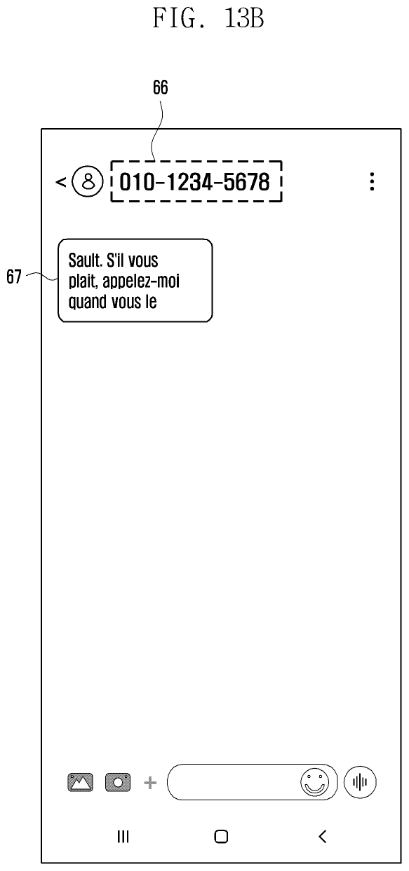

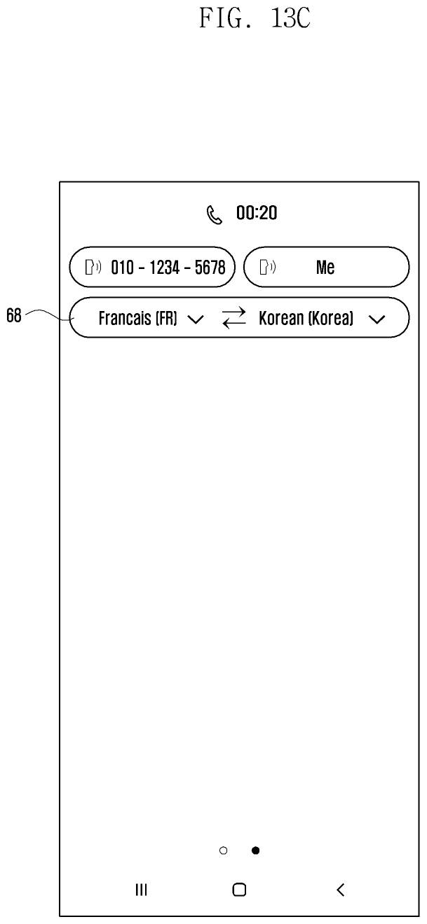

FIGS. 13A, 13B, and 13C are diagrams illustrating an operation of configuring a language of a counterpart, based on additional information according to various embodiments of the disclosure.

Referring to FIG. 13A, an electronic device 200 may receive a call from a specific number 66. The specific number 66 may be a number not stored in the electronic device 200. When the electronic device 200 fails to receive information about a counterpart from a server, when a language of the counterpart is not configured, or when the electronic device 200 fails to determine the location of the counterpart from the phone number, the electronic device 200 may determine and configure the language of the counterpart by using additional information.

Referring to FIG. 13B, in an example, the electronic device 200 may receive a message 67 from the specific number 66 before a call. The electronic device 200 may determine the language of the counterpart of the specific number 66, based on a language in which the message is written. In an example, the message received from the specific number 66 may be a message 67 written in French. The electronic device 200 may determine that the counterpart is a user using French, and may configure a language for the specific number 66 to French.

Referring to FIG. 13C, the electronic device 200 may execute an interpretation function, based on a configured language of the user and the language of the counterpart. For example, the electronic device 200 may display a conversation script. The conversation script may include the counterpart's number and information related to the counterpart's configured language and/or the user's configured language. In an example, the electronic device 200 may determine that the counterpart's language is French, and may thus display French 68 as the information related to the counterpart's language.

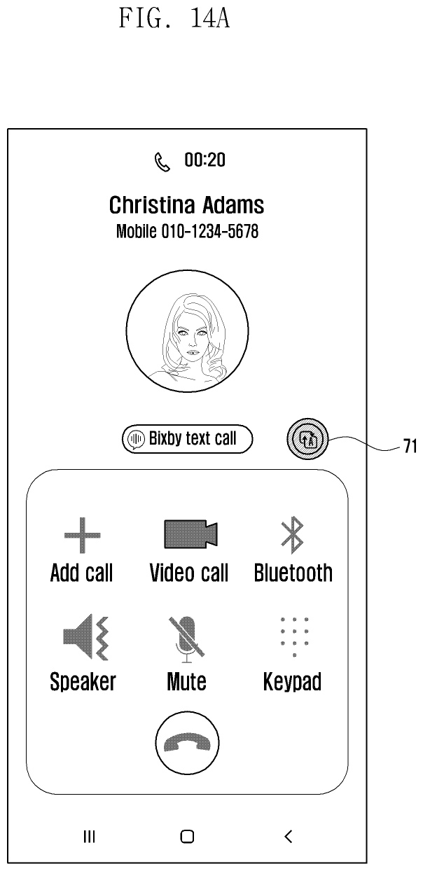

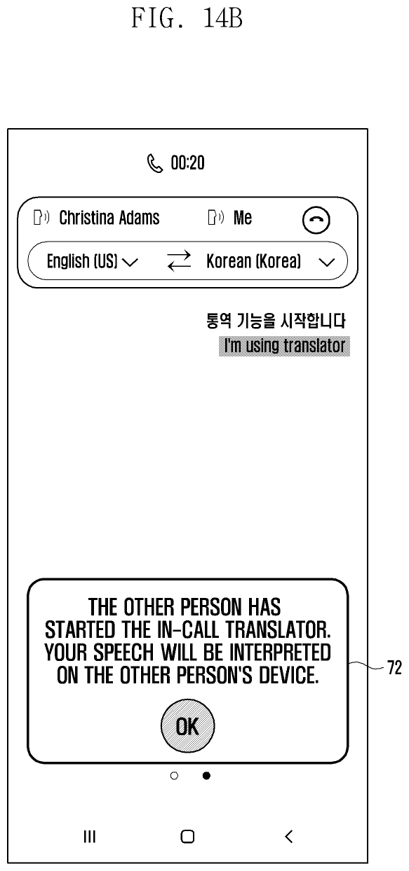

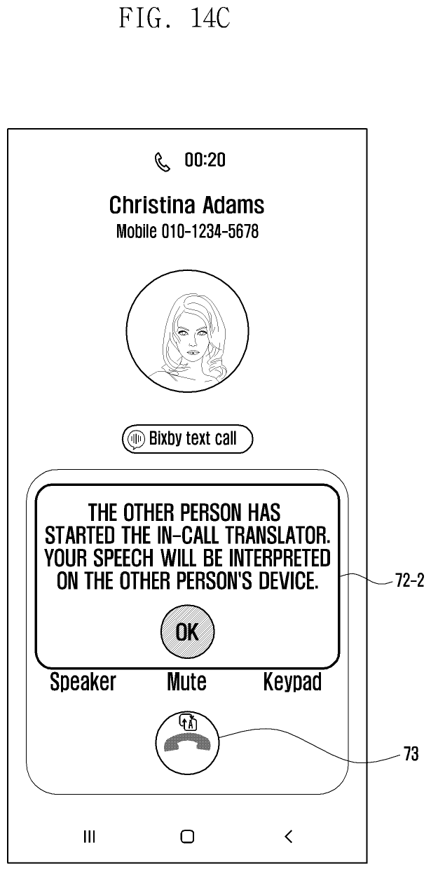

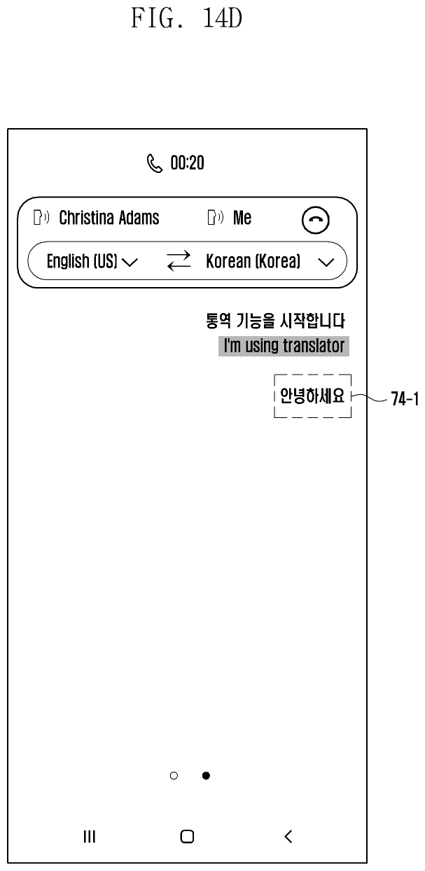

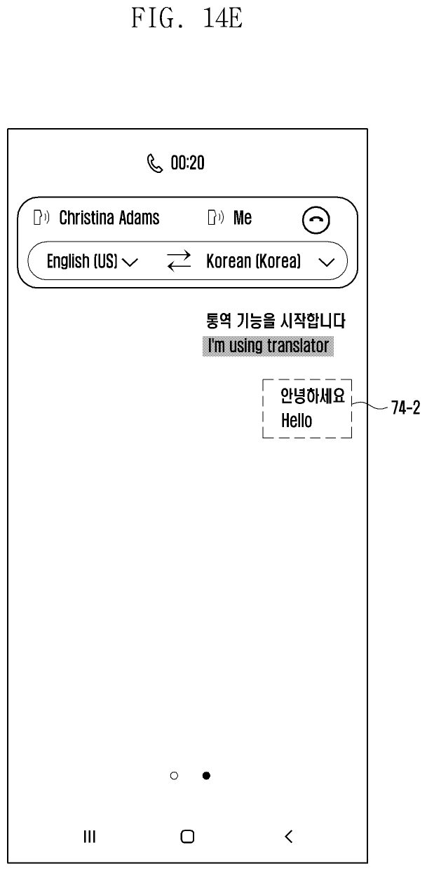

FIGS. 14A, 14B, 14C, 14D, and 14E are diagrams illustrating a screen displayed on an electronic device of a user when an interpretation function is executed according to various embodiments of the disclosure.

Referring to FIG. 14A, a call UI is illustrated. In an example, the call UI may include an interpretation function on/off item 71. When the interpretation function on/off item 71 is enabled, an electronic device 200 (e.g., a first electronic device) of a user (e.g., a first user) may identify information about a counterpart through a server. For example, the electronic device 200 of the user may identify a country code and an area code of a number of the counterpart (e.g., a second user), system language information about the electronic device of the counterpart, a manufacturer of an electronic device (e.g., a second electronic device) of the counterpart, a model name of the electronic device of the counterpart, and/or interpretation function support information about the electronic device of the counterpart.

The electronic device 200 of the user may identify whether the electronic device of the counterpart supports an interpretation function, based on the identified information about the counterpart. For example, when the electronic device of the counterpart does not support the interpretation function, the electronic device 200 of the user may execute the interpretation function alone without a separate notification. When the electronic device of the counterpart supports the interpretation function, the electronic device 200 of the user may provide the counterpart with a notification regarding execution of the interpretation function. In an example, the electronic device of the counterpart may support the interpretation function, and may also turn on the interpretation function. When the interpretation function of the electronic device of the counterpart is enabled, the electronic device of the counterpart may provide a notification regarding execution of the interpretation function to the electronic device 200 of the user.

Referring to FIG. 14B, the electronic device 200 of the user may display the notification 72 received from the electronic device of the counterpart. When the electronic device 200 of the user and the electronic device of the counterpart support the interpretation function and both execute the interpretation function, the electronic device 200 of the user and the electronic device of the counterpart may interpret only an utterance transmitted or received thereby.

For example, the electronic device 200 of the user and the electronic device of the counterpart may interpret only an utterance transmitted thereby.

In an example, the electronic device 200 of the user may convert an utterance of the user (e.g., the first user) into text, and may display the converted text on a conversation script. The electronic device 200 of the user may generate text by translating the user's utterance (or converted text) into a language of the counterpart (e.g., the second user), and may convert the generated text into a TTS audio signal. The electronic device 200 of the user may display the translated text in the language of the counterpart on the conversation script. In addition, the electronic device 200 of the user may transmit the user's utterance, the text of the user's utterance, the translated text of the user's utterance in the language of the counterpart, and/or the TTS audio signal obtained by translating the user's utterance to the electronic device of the counterpart. The electronic device of the counterpart may convert an utterance of the counterpart into text, and may display the converted text on a conversation script.

The electronic device of the counterpart may generate text by translating the counterpart's utterance (or converted text) into a language of the user, and may convert the generated text into a TTS audio signal. The electronic device of the counterpart may display the translated text in the language of the user on the conversation script. In addition, the electronic device of the counterpart may transmit the counterpart's utterance, the text of the counterpart's utterance, the translated text of the counterpart's utterance in the language of the user, and/or the TTS audio signal obtained by translating the counterpart's utterance into the electronic device 200 of the user. The electronic device 200 of the user may display the text converted from the counterpart's utterance and/or the translated text from the counterpart's utterance in the language of the user on the conversation script.

For example, the electronic device 200 of the user and the electronic device of the counterpart may interpret only an utterance received thereby.

In an example, the electronic device 200 of the user may convert an utterance of the user into text, and may display the converted text on a conversation script. In addition, the electronic device 200 of the user may transmit the user's utterance and/or the text of the user's utterance to the electronic device of the counterpart.

The electronic device of the counterpart may convert the received user's utterance into text to display the text on a conversation script, or may display text of the received user's utterance on the conversation script. The electronic device of the counterpart may generate text by translating the user's utterance (or the text of the user's utterance) into the language of the counterpart, and may convert the generated text into a TTS audio signal. The electronic device of the counterpart may display the translated text in the language of the counterpart on the conversation script.

The electronic device of the counterpart may convert an utterance of the counterpart into text, and may display the converted text on the conversation script. In addition, the electronic device of the counterpart may transmit the counterpart's utterance and/or the text of the counterpart's utterance to the electronic device 200 of the user.

The electronic device 200 of the user may convert the received counterpart's utterance into text to display the text on the conversation script, or may display text of the received counterpart's utterance on the conversation script. The electronic device 200 of the user may generate text by translating the counterpart's utterance (or the text of the counterpart's utterance) into the language of the user, and may convert the generated text into a TTS audio signal. The electronic device 200 of the user may display the translated text in the language of the user on the conversation script.

Referring to FIG. 14C, the electronic device 200 may automatically perform the interpretation function. For example, when the electronic device 200 receives a call from the electronic device of the counterpart, the electronic device 200 may identify whether the interpretation function of the electronic device of the counterpart is enabled/disabled. The electronic device 200 may identify information about the electronic device of the counterpart from the server. In an example, the electronic device 200 may identify the interpretation function support information about the electronic device of the counterpart and whether the interpretation function is enabled/disabled through the server. In an example, when the electronic device of the counterpart supports the interpretation function, the electronic device 200 may identify whether the interpretation function is enabled/disabled directly through the electronic device of the counterpart.

When the interpretation function of the electronic device of the counterpart is enabled, the electronic device 200 may display a notification 72-2 indicating that the interpretation function of the electronic device of the counterpart is enabled. In an example, when the interpretation function of the electronic device of the counterpart is enabled, the electronic device 200 may change an answer button 73 to display an image (or icon) indicating that the interpretation function is automatically performed upon receiving a call from the counterpart. When the answer button (call button) 73 is selected, the electronic device 200 may automatically perform the interpretation function upon receiving the call. Referring to FIG. 14D, in an example, illustrated is a conversation script displayed on the electronic device 200 of the user in a case where the electronic device 200 of the user and the electronic device of the counterpart interpret only a received utterance. The electronic device 200 of the user interprets only a received utterance (e.g., the counterpart's utterance), and may thus display text 74-1 converted from the user's utterance on the conversation script, without displaying text translated into the language of counterpart.

Referring to FIG. 14E, in an example, illustrated is a conversation script displayed on the electronic device 200 of the user in a case where the electronic device 200 of the user and the electronic device of the counterpart interpret only a transmitted utterance. The electronic device 200 of the user interprets only a transmitted utterance (e.g., the user's utterance), and may thus display text converted from the user's utterance and translated text 74-2 in the language of the counterpart on the conversation script.

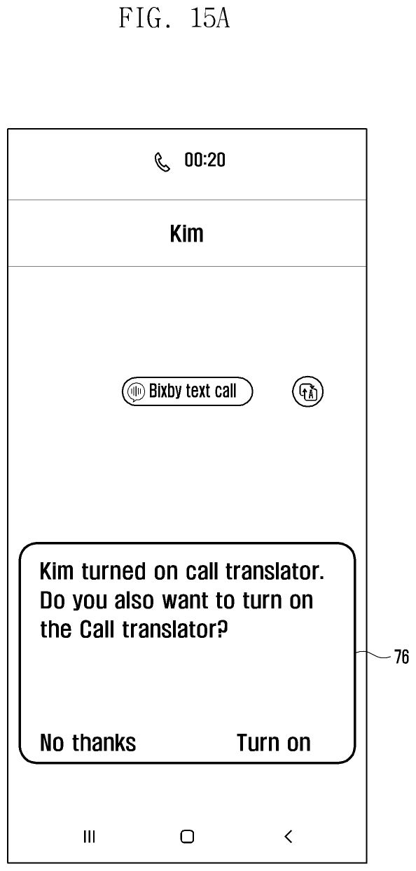

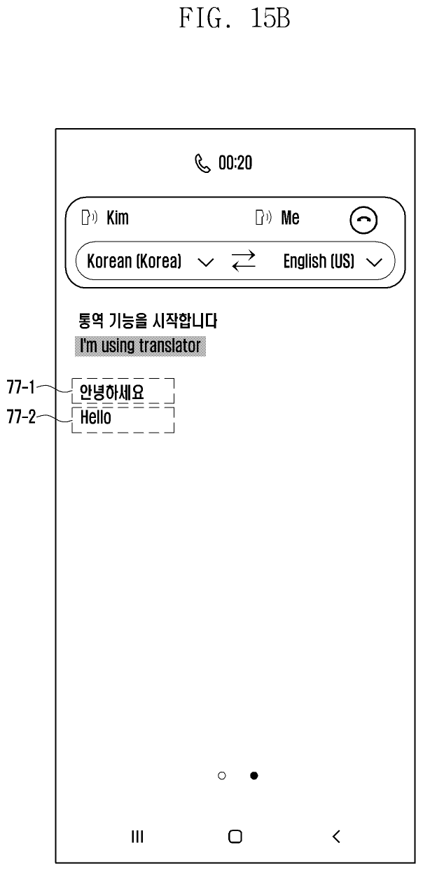

FIGS. 15A and 15B are diagrams illustrating a screen displayed on an electronic device of a counterpart when an interpretation function is executed according to various embodiments of the disclosure.

Referring to FIG. 15A, an electronic device (e.g., a second electronic device) of a counterpart may display a notification 76 received from an electronic device 200 (e.g., a first electronic device) of a user. For example, the received notification 76 may be a notification inquiring whether an interpretation function is enabled in the electronic device of the counterpart. In an example, when the interpretation function is disabled (or execution of the interpretation function is not selected) in the electronic device of the counterpart (e.g., a second user) according to a command of the counterpart, the electronic device of the counterpart may not perform the interpretation function, and only the electronic device 200 of the user may perform the interpretation function. In an example, when the interpretation function is enabled (or execution of the interpretation function is selected) in the electronic device of the counterpart according to a command of the counterpart, the electronic device 200 of the user and the electronic device of the counterpart may interpret only an utterance transmitted or received thereby.

The electronic device of the counterpart may automatically perform the interpretation function, as described in FIG. 14C. For example, when receiving a call from the electronic device 200 of the user, the electronic device of the counterpart may identify whether the interpretation function of the electronic device 200 of the user is enabled/disabled. The electronic device of the counterpart may identify information about the electronic device 200 of the user from a server. In an example, the electronic device of the counterpart may identify interpretation function support information about the electronic device 200 of the user and whether the interpretation function is enabled/disabled through the server. In an example, when the electronic device 200 of the user supports the interpretation function, the electronic device of the counterpart may identify whether the interpretation function is enabled/disabled directly through the electronic device 200 of the user.

When the interpretation function of the electronic device 200 of the user is on, the electronic device of the counterpart may display a notification indicating that the interpretation function of the electronic device 200 of the user is enabled. In an example, when the interpretation function of the electronic device 200 of the user is enabled, the electronic device of the counterpart may change an answer button to display an image (or icon) indicating that the interpretation function is automatically performed upon receiving a call. When the answer button (call button) is selected, the electronic device of the counterpart may automatically perform the interpretation function upon receiving the call.

Referring to FIG. 15B, in an example, illustrated is a conversation script displayed on the electronic device of the counterpart in a case where the electronic device 200 of the user and the electronic device of the counterpart interpret only a received utterance. The electronic device of the counterpart may convert a received utterance of the user into text 77-1 to display the text on a conversation script, or may display text 77-1 of the received utterance of the user on the conversation script. The electronic device of the counterpart may generate text 77-2 by translating the user's (e.g., first user's) utterance (or the text of the user's utterance) into a language of the counterpart (e.g., the second user), and may convert the generated text 77-2 into a TTS audio signal. The electronic device of the counterpart may display the translated text 77-2 in the language of the counterpart on the conversation script.

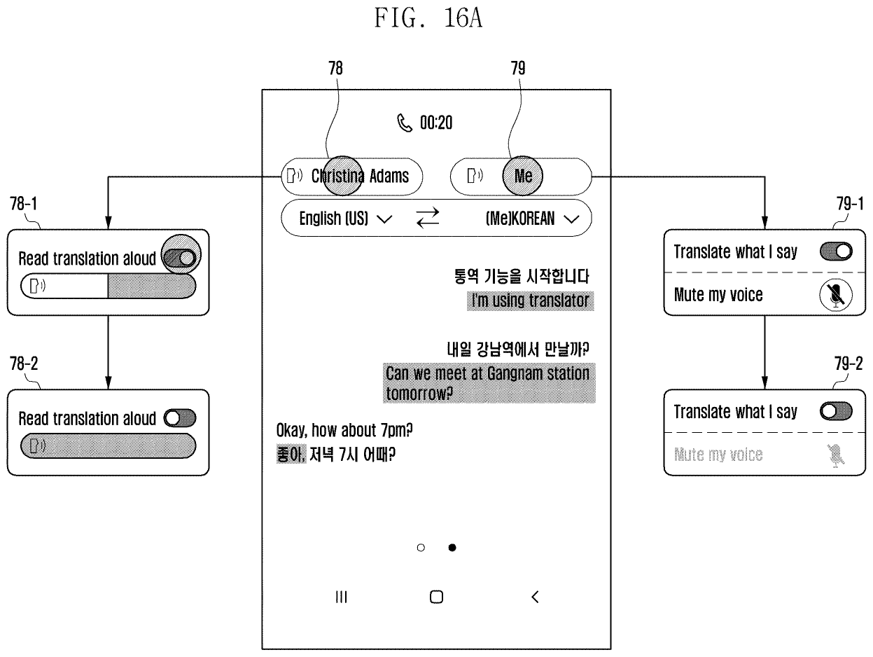

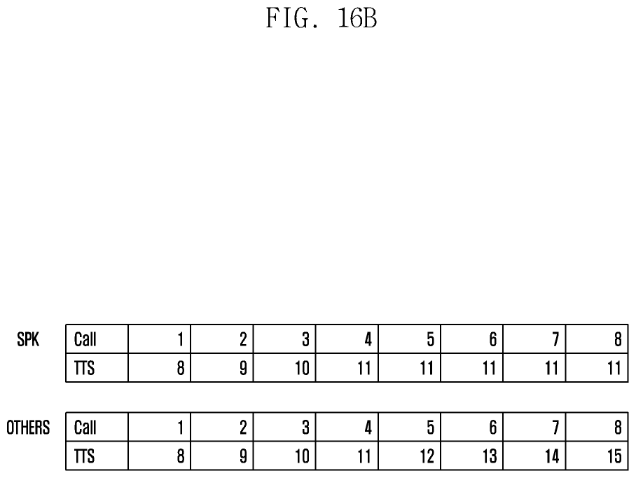

FIG. 16A is a diagram illustrating a conversation script screen including a configuration option according to an embodiment of the disclosure.

Referring to FIG. 16A, an electronic device 200 may display an interpretation-related option on a conversation script screen. For example, the interpretation-related option may include a first option for selecting whether to output a TTS audio signal obtained by interpreting a counterpart's utterance, a second option for selecting whether to interpret a user's utterance, and/or a third option for selecting whether to mute the user's utterance.

In an example, counterpart information 78 displayed on the conversation script screen may be selected. When the counterpart information 78 is selected, the electronic device 200 may display the first option 78-1 for selecting whether to output the TTS audio signal obtained by interpreting the counterpart's utterance. When the first option is enabled (or turned on) (78-1), the electronic device 200 may translate the counterpart's utterance, and may output a TTS audio signal generated based on a translation result. The electronic device 200 may display an image effect on translated text displayed on the conversation script screen in synchronization with output of the TTS audio signal. When the first option is disabled (or turned off) (78-2), the electronic device 200 may not output the TTS audio signal. The electronic device 200 may not display an image effect on the translated text displayed on the conversation script screen.

In an example, user information 79 displayed on the conversation script screen may be selected. When the user information 79 is selected, the electronic device 200 may display the second option for selecting whether to interpret the user's utterance and/or the third option for selecting whether to mute the user's utterance.

For example, when the second option is enabled (or turned on) (79-1), the electronic device 200 may translate the user's utterance, and may transmit a TTS audio signal generated based on a translation result to the electronic device of the counterpart. The electronic device of the counterpart may output the received TTS audio signal. When the second option is enabled (79-1), the third option may be selected. For example, when the third option is disabled (or turned off), the electronic device 200 may transmit the user's utterance and the TTS audio signal generated based on the translation result of the user's utterance to the electronic device of the counterpart. The electronic device of the counterpart may sequentially output the received user's utterance and TTS audio signal. When the third option 79-2 is enabled (or turned on), the electronic device 200 may transmit the TTS audio signal generated based on the translation result of the user's utterance to the electronic device of the counterpart, without transmitting the user's utterance. The electronic device of the counterpart may output the received TTS audio signal.

For example, when the second option is disabled (or turned off) (79-2), the electronic device 200 may not interpret the user's utterance. In addition, since the electronic device 200 does not interpret the user's utterance, the electronic device 200 may dim (or deactivate) the third option for selecting whether to mute the user's utterance.

In an example, an interpretation option related to the counterpart information 78 may include a fourth option for selecting whether to transmit a second TTS audio signal. The second TTS audio signal may be an audio signal generated by translating the counterpart's utterance into a language of the user. When the counterpart information 78 is selected, the electronic device 200 may display the fourth option together with the first option 78-1.

When the fourth option is enabled, the electronic device 200 may transmit the second TTS audio signal to the electronic device of the counterpart. The electronic device of the counterpart may output the received second TTS audio signal. In an example, the electronic device of the counterpart may output the second TTS audio signal at a volume smaller than a volume at which the user's utterance is output. When the fourth option is disabled, the electronic device 200 may not transmit the second TTS audio signal to the electronic device of the counterpart.

FIG. 16B is a diagram illustrating volume of an utterance and/or a TTS audio signal according to an embodiment of the disclosure.

Referring to FIG. 16B, for example, volume levels of a counterpart's utterance and a second TTS audio signal output via a loudspeaker and volume levels of the utterance and the TTS audio signal output via a different output device (e.g., an earphone) are illustrated.

For example, an electronic device 200 may translate the counterpart's utterance, and may generate a second TTS audio signal corresponding to the translated counterpart's utterance. The electronic device 200 may output the counterpart's utterance and/or the second TTS audio signal. In an example, the electronic device 200 may output the counterpart's utterance at a second level of volume, and may output the second TTS audio signal at a third level of volume greater than the second level. For example, as illustrated in FIG. 16B, the electronic device 200 may output the counterpart's utterance at a volume of 3, and may output the second TTS audio signal at a volume of 10. When the volume exceeds a certain level, the electronic device 200 may limit the output volume of the loudspeaker in order to prevent howling and/or echo caused by the loudspeaker's output entering a microphone. As illustrated in FIG. 16B, when the output volume of the loudspeaker is 11, the electronic device 200 may not increase the volume of the second TTS audio signal even though the volume of the counterpart's utterance increases. When the counterpart's utterance and/or the second TTS audio signal are output through the different output device, the electronic device 200 may output the counterpart's utterance and/or the second TTS audio signal at a greater volume level because no howling and/or echo occurs.

The electronic device 200 may translate a user's utterance, and may generate a first TTS audio signal corresponding to the translated user's utterance. In an example, the electronic device 200 may output the first TTS audio signal. The electronic device 200 may output the first TTS audio signal at a first level of volume smaller than the second level of volume. For example, when outputting the counterpart's utterance at a volume of 3, the electronic device 200 may output the first TTS audio signal at a volume of 1. In an example, the electronic device 200 may map (or group) the volume of the counterpart's utterance, the volume of the first TTS audio signal, and/or the volume of the second TTS audio signal with each other. The volume of the counterpart's utterance, the volume of the first TTS audio signal, and/or the volume of the second TTS audio signal may increase or decrease together in response to an increase or decrease in volume.

For example, the electronic device 200 may adjust the volume, based on an input of a volume key disposed on a side thereof. In an example, the electronic device 200 may adjust the volume, based on a touch gesture input on a screen.

For example, an electronic device of the counterpart may output the user's utterance, the first TTS audio signal corresponding to the translated user's utterance, and/or the second TTS audio signal corresponding to the translated counterpart's utterance. In an example, the electronic device of the counterpart may output the user's utterance at a fifth level of volume, output the first TTS audio signal at a sixth level of volume (greater than the fifth level), and output the second TTS audio signal at a fourth level of volume (smaller than the fifth level).

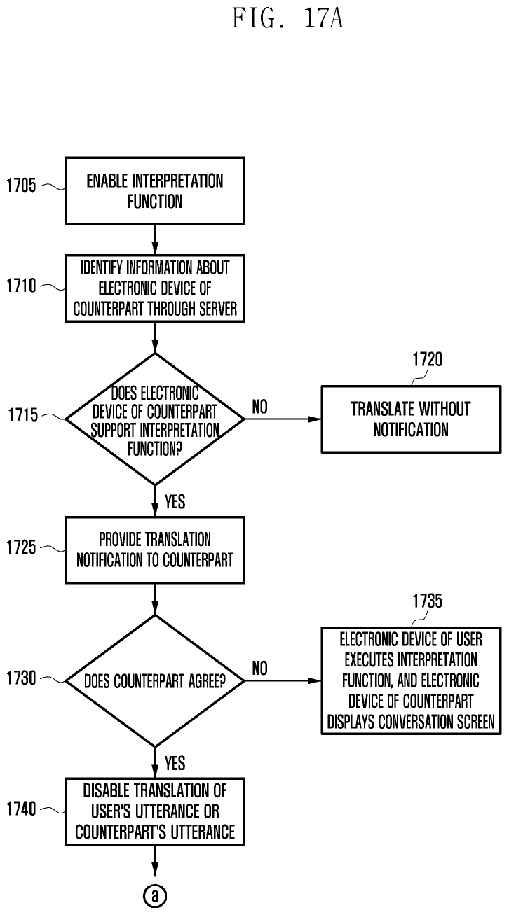

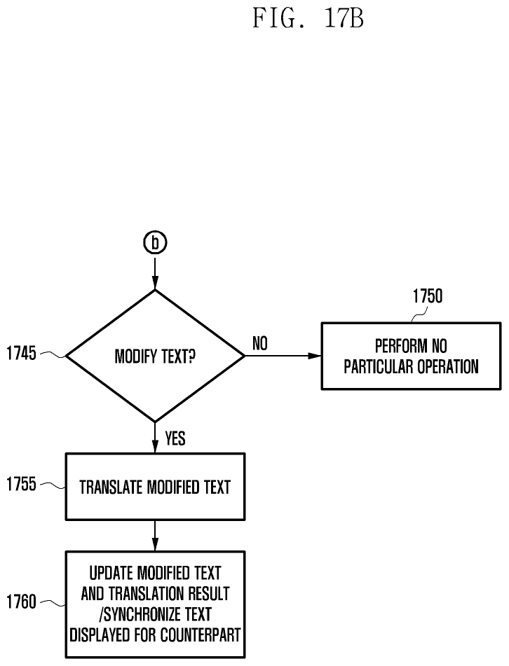

FIGS. 17A and 17B are flowcharts illustrating an operation in which an electronic device of a user and an electronic device of a counterpart execute an interpretation function together according to various embodiments of the disclosure.

In the following embodiments, operations may be sequentially performed but are not necessarily sequentially performed. For example, the order of the operations may be changed, and at least two operations may be performed in parallel.

According to an embodiment, operations 1705 to 1760 may be construed as being performed by a processor (e.g., the processor 250 of FIG. 2) of an electronic device (e.g., the electronic device 200 of FIG. 2).

Referring to FIG. 17A, the electronic device 200 may turn on an interpretation function at operation 1705, and may identify information about an electronic device of a counterpart through a server at operation 1710. For example, the information about the electronic device of the counterpart may include a country code and an area code of a number of the counterpart, system language information about the electronic device of the counterpart, a manufacturer of the electronic device of the counterpart, a model name of the electronic device of the counterpart, and/or interpretation function support information about the electronic device of the counterpart.

The electronic device 200 may determine whether the electronic device of the counterpart supports the interpretation function, based on the identified information about the electronic device of the counterpart at operation 1715. When the electronic device of the counterpart does not support the interpretation function (NO in 1715), the electronic device 200 may perform the interpretation function without a notification at operation 1720.

When the electronic device of the counterpart supports the interpretation function (YES in 1715), the electronic device 200 may provide a notification regarding execution of the interpretation function to the counterpart at operation 1725. The electronic device of the counterpart may display the notification received from the electronic device 200 of the user. For example, the received notification may be a notification of inquiring whether the interpretation function is enabled in the electronic device of the counterpart. The electronic device 200 may determine whether the counterpart agrees at operation 1730. For example, when the interpretation function is enabled in the electronic device of the counterpart, the electronic device 200 may determine that the counterpart has agreed. When the interpretation function is disabled in the electronic device of the counterpart, the electronic device 200 may determine that the counterpart has not agreed.

When the counterpart does not agree about the interpretation function (NO in 1730), the electronic device 200 may execute the interpretation function, and the electronic device of the counterpart may display a conversation script screen at operation 1735. For example, the electronic device 200 may convert the user's utterance into first text, and may display the converted first text. In addition, the electronic device 200 may generate and display second text obtained by translating the user's utterance (or first text) into a language of the counterpart. The electronic device 200 may convert the second text into a first TTS audio signal. The electronic device 200 may transmit the user's utterance, the first TTS audio signal, the first text, and/or the second text to the electronic device of the counterpart. The electronic device of the counterpart may output the user's utterance and/or the first TTS audio signal, and display the first text and/or the second text on the conversation script screen, based on data received from the electronic device 200.

The server may manage a conversation script. For example, the server may generate one conversation script including text data received from the electronic device 200 of the user and text data received from the electronic device of the counterpart, and manage the generated one conversation script. In an example, the server may generate a first conversation script displayed on the electronic device 200 of the user and a second conversation script displayed on the electronic device of the counterpart. The server may manage the first conversation script and the second conversation script in synchronization.

When the counterpart agrees about the interpretation function (YES in 1730), the electronic device 200 may disable interpretation of the user's utterance or the counterpart's utterance at operation 1740. When the interpretation of the user's utterance is disabled, the electronic device 200 may interpret the counterpart's utterance. In addition, the electronic device of the counterpart may interpret the user's utterance. When the interpretation of the counterpart's utterance is disabled, the electronic device 200 may interpret the user's utterance. In addition, the electronic device of the counterpart may interpret the counterpart's utterance.

Referring to FIG. 17B, the electronic device 200 may determine whether to modify text displayed on a conversation script at operation 1745. When the electronic device 200 determines that there is no modification to the text displayed on the conversation script (NO in 1745), the electronic device 200 may not perform any particular operation at operation 1750. When the electronic device 200 determines that the text displayed on the conversation script has been modified (YES in 1745), the electronic device 200 may update the modified text and a translation result at operation 1755. In addition, the conversation script updated in the electronic device 200 may be synchronized with a conversation script displayed on the electronic device of the counterpart by the server at operation 1760.

For example, when text on a conversation script displayed on the electronic device 200 is modified, the electronic device 200 may transmit information about the modified text to the server. In an example, when the server manages a single conversation script, the server may update text on the single conversation script, based on the information about the modified text. The server may transmit the updated conversation script or an update notification to the electronic device of the counterpart. The electronic device of the counterpart may receive the updated conversation script or the information about the modified text, and may update a conversation script displayed on the electronic device of the counterpart. In an example, when the server manages a first conversation script and a second conversation script, the server may update the first conversation script, based on the information about the modified text. In addition, the server may synchronize the first conversation script and the second conversation script. The server may transmit the updated second conversation script or an update notification to the electronic device of the counterpart. The electronic device of the counterpart may receive the updated second conversation script or the information about the modified text, and may update the conversation script displayed on the electronic device of the counterpart.

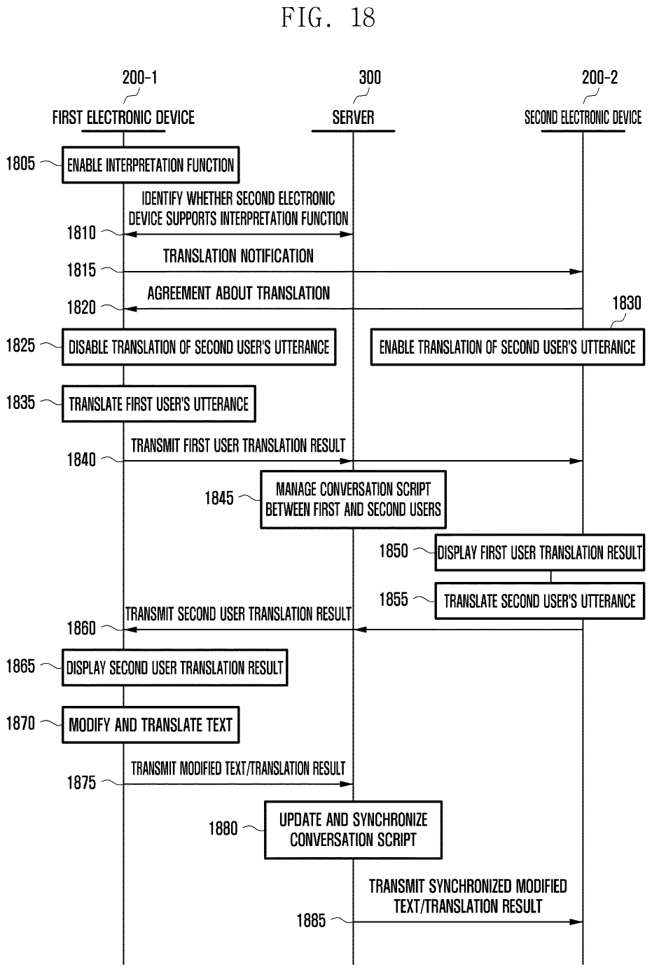

FIG. 18 is a timing diagram illustrating an operation in which an electronic device of a user and an electronic device of a counterpart execute an interpretation function together according to an embodiment of the disclosure.

In the following embodiments, operations may be sequentially performed but are not necessarily sequentially performed. For example, the order of the operations may be changed, and at least two operations may be performed in parallel.

According to an embodiment, operations 1805 to 1885 may be construed as being performed by an electronic device (e.g., the electronic device 200 of FIG. 2 and/or the electronic device 102 or 104 of FIG. 1) and a server (e.g., the server 108 of FIG. 1).

Referring to FIG. 18, a first electronic device 200-1 (e.g., a user electronic device) may turn on an interpretation function at operation 1805, and may identify whether a second electronic device 200-2 (e.g., a counterpart electronic device) supports the interpretation function at operation 1810. For example, the first electronic device 200-1 may identify information about the second electronic device 200-2 from a server 300. The information about the second electronic device 200-2 may include a country code and an area code of a number of the counterpart, system language information about the second electronic device 200-2, a manufacturer of the second electronic device 200-2, a model name of the second electronic device 200-2, and/or interpretation function support information about the second electronic device 200-2.

When the second electronic device 200-2 supports the interpretation function, the first electronic device 200-1 may transmit a notification regarding execution of the interpretation function to the second electronic device 200-2 at operation 1815, and may receive an agreement about execution of the interpretation function from the second electronic device 200-2 at operation 1820.

In an example, when the second electronic device 200-2 agrees to execute the interpretation function, the first electronic device 200-1 may disable an utterance translation function for a second user (e.g., a user of the second electronic device 200-2) at operation 1825, and the second electronic device 200-2 may enable an utterance translation function for the second user at operation 1830. In other words, the first electronic device 200-1 and the second electronic device 200-2 may perform interpretation of a transmitted utterance. In another example, the first electronic device 200-1 may disable an utterance translation function for a first user (e.g., a user of the first electronic device 200-1), and the second electronic device 200-2 may enable an utterance translation function for the first user. In other words, the first electronic device 200-1 and the second electronic device 200-2 may perform interpretation of a received utterance.

When the first electronic device 200-1 and the second electronic device 200-2 perform interpretation of a transmitted utterance, the first electronic device 200-1 may translate the first user's utterance at operation 1835, and may transmit a translation result to the server 300 and the second electronic device 200-2 at operation 1840. The server 300 may manage a conversation script between the first and second users at operation 1845.

The second electronic device 200-2 may display the received translation result of the first user's utterance at operation 1850. The second electronic device 200-2 may translate the second user's utterance at operation 1855, and may transmit a translation result to the server 300 and the first electronic device 200-1 at operation 1860.

The first electronic device 200-1 may display the translation result of the received second user's utterance at operation 1865. The first electronic device 200-1 may modify text displayed on the conversation script according to an input of the user, and may translate the modified text at operation 1870. The first electronic device 200-1 may transmit the modified text and a translation result to the server 300 at operation 1875.

The server 300 may update and/or synchronize the managed conversation script, based on the received modified text and translation result at operation 1880. For example, when managing a single conversation script, the server 300 may update the single conversation script. In an example, the server 300 may manage a first conversation script displayed on the first electronic device 200-1 and a second conversation script displayed on the second electronic device 200-2. The server 300 may update the first conversation script and synchronize the second conversation script, based on the received modified text and the translation result. The server 300 may transmit the synchronized modified text and translation result to the second electronic device 200-2 at operation 1885. The second electronic device 200-2 may update the displayed conversation script.

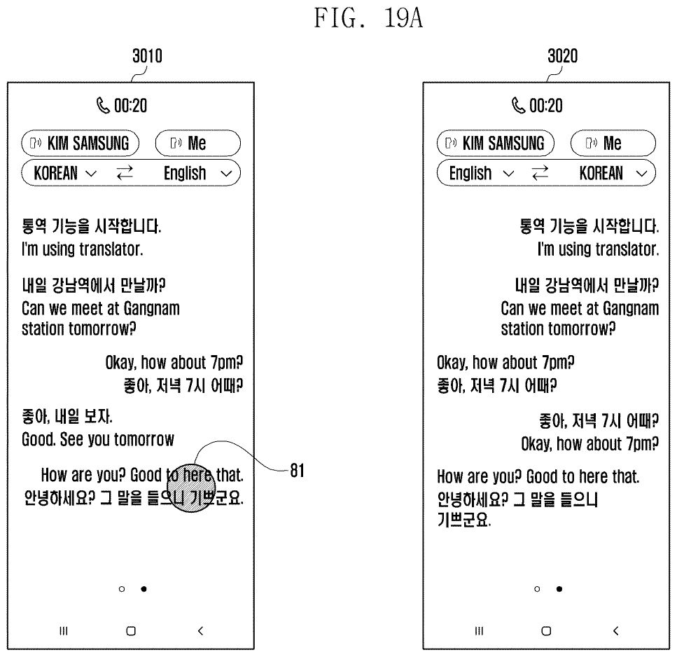

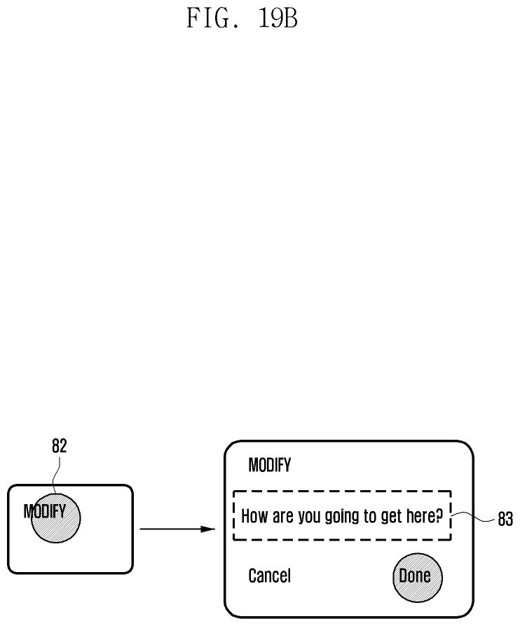

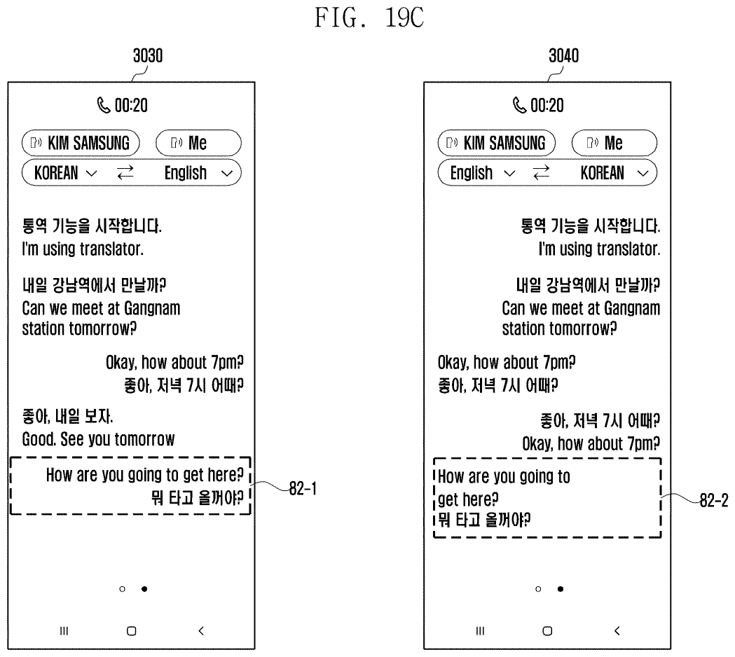

FIGS. 19A, 19B, and 19C are diagrams illustrating an operation of modifying text displayed on a conversation script according to various embodiments of the disclosure.

FIG. 19A illustrates a conversation script screen 3010 displayed on a first electronic device 200-1 (e.g., an electronic device 200 of a user) and a conversation script screen 3020 displayed on a second electronic device 200-2 (e.g., an electronic device of a counterpart). The first electronic device 200-1 and the second electronic device 200-2 may each translate a transmitted or received utterance, and may display a translation result. In an example, the first electronic device 200-1 and the second electronic device 200-2 may display text of “How are you? Good to hear that” uttered by the first user and text of “Annyeonghaseyo? Geu maleul deuleuni gippeugunyo” obtained by translating the first user's utterance. The first electronic device 200-1 may receive an input 81 for modifying the first user's utterance.

Referring to FIG. 19B, the first electronic device 200-1 may display an edit menu 82 upon receiving a user input on the displayed text. When the edit menu is selected, the first electronic device 200-1 may display a UI 83 for modifying the text of the first user's utterance (or the text translated from the first user's utterance). In an example, the first electronic device 200-1 may receive an input for modifying “How are you? Good to hear that” to “How are you going to get here?” from the first user.

Referring to FIG. 19C, illustrated are a conversation script screen 3030 of the first electronic device 200-1 and a conversation script screen 3040 of the second electronic device 200-2 which display modified text in synchronization. When the text is completely modified, the first electronic device 200-1 may translate the modified text. In an example, the first electronic device 200-1 may display text of “Mwo tago olkkeoya?” translated from the modified of “How are you going to get here?” The first electronic device 200-1 may transmit the modified text and the translated text to a server.

For example, the server may manage a conversation script. In an example, the server 300 may generate a single conversation script including text data received from the first electronic device 200-1 and text data received from the second electronic device 200-2, and may manage the generated single conversation script. In another example, the server 300 may generate a first conversation script displayed on the first electronic device 200-1 and a second conversation script displayed on the second electronic device 200-2. The server 300 may manage the first conversation script and the second conversation script in synchronization. When the server 300 receives the modified text and the translated text from the first electronic device 200-1, the server 300 may update one conversation script. In an example, the server 300 may update the first conversation script, and may synchronize the second conversation script with the first conversation script.

The server 300 may transmit information about the updated second conversation script to the second electronic device 200-2. In an example, the server 300 may transmit information about a notification of the conversation script, the updated conversation script, and/or the modified/translated text to the second electronic device 200-2. The second electronic device 200-2 may update the displayed conversation script, based on the received information. In an example, when the utterance text and the translated text of the conversation script on the first electronic device 200-1 are modified to text 82-1 of “How are you going to get here?” and “Mwo tago olkkeoya?” respectively, the second electronic device 200-2 may update the text to the modified text 82-2 in synchronization with the conversation script on the first electronic device 200-1.

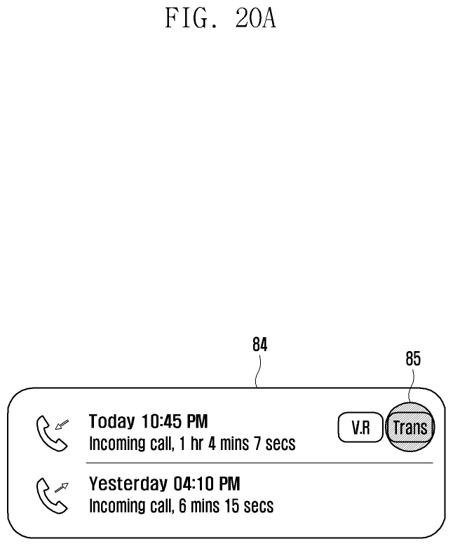

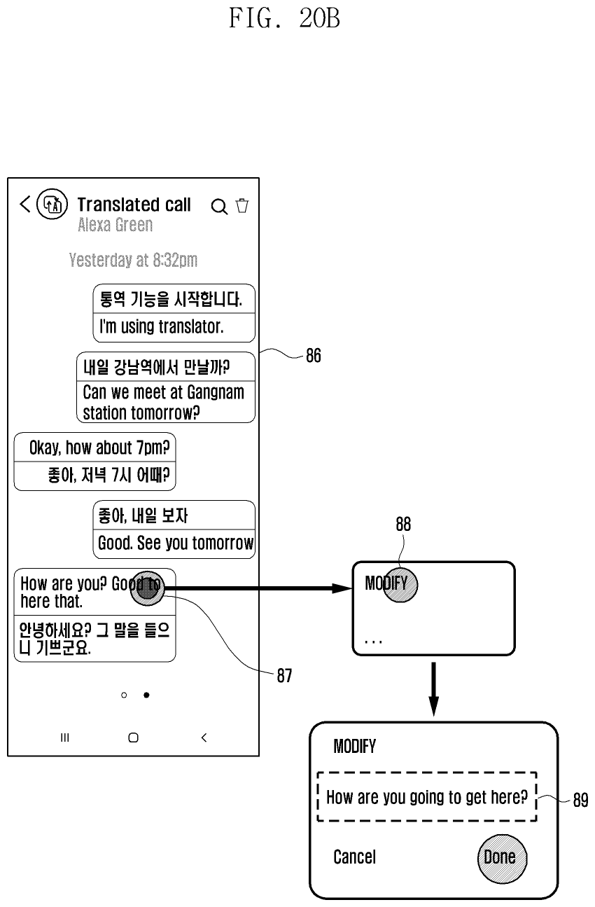

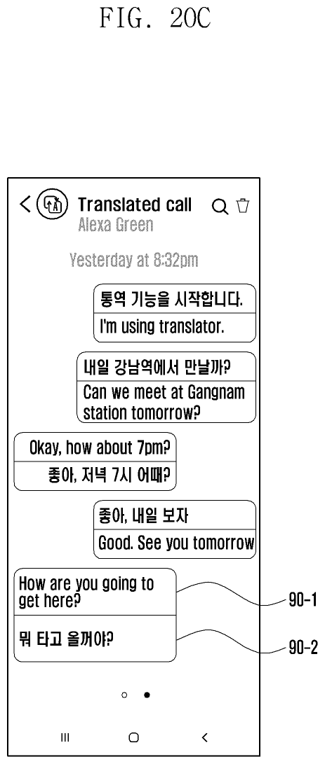

FIGS. 20A, 20B, and 20C are diagrams illustrating an operation of modifying text displayed in a call history according to various embodiments of the disclosure.

Referring to FIG. 20A, a conversation history 84 stored in an electronic device 200 is illustrated. The electronic device 200 may edit text included in the stored conversation history 84. The electronic device 200 may receive an input for selecting (85) one conversation history from a user.

Referring to FIG. 20B, a conversation script screen 86 of a selected conversation history is illustrated. When one conversation history is selected, the electronic device 200 may display a conversation script 86 of the selected conversation history. When receiving an input 87 for modifying text on the displayed conversation script, the electronic device 200 may display an edit menu 88 for selected text. When the edit menu 88 is selected, the electronic device 200 may display a UI 89 for modifying text of a first user's utterance (or translated text of the first user's utterance). In an example, the electronic device 200 may receive an input for modifying “How are you? Good to hear that” to “How are you going to get here?” from the first user.

Referring to FIG. 20C, a conversation script with modified text is illustrated. After modification of text is completed, the electronic device 200 may translate the modified text. In an example, the electronic device 200 may display text 90-2 of “Mwo tago olkkeoya?” which is a translation of the modified text 90-1 of “How are you going to get here?” The electronic device 200 may transmit the modified text and the translated text to a server 300. The server 300 may update the conversation script displayed on the electronic device 200, and may synchronize a conversation script displayed on an electronic device of a counterpart. When the server transmits information about the updated second conversation script to the electronic device of the counterpart, the electronic device of the counterpart may update the corresponding conversation script.

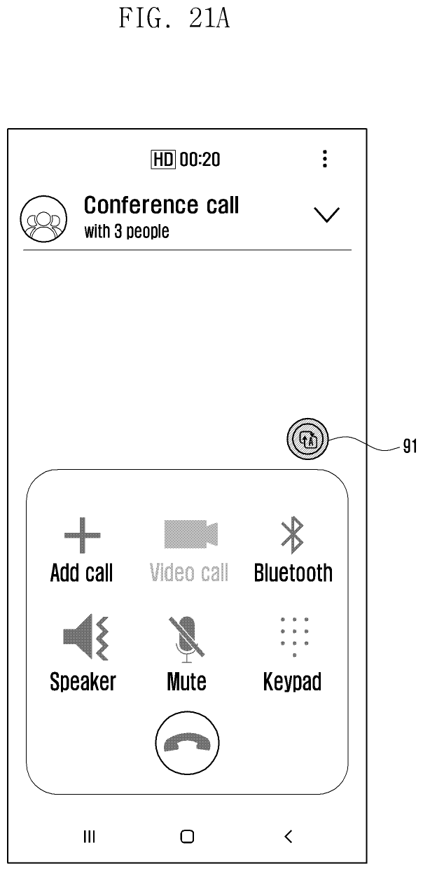

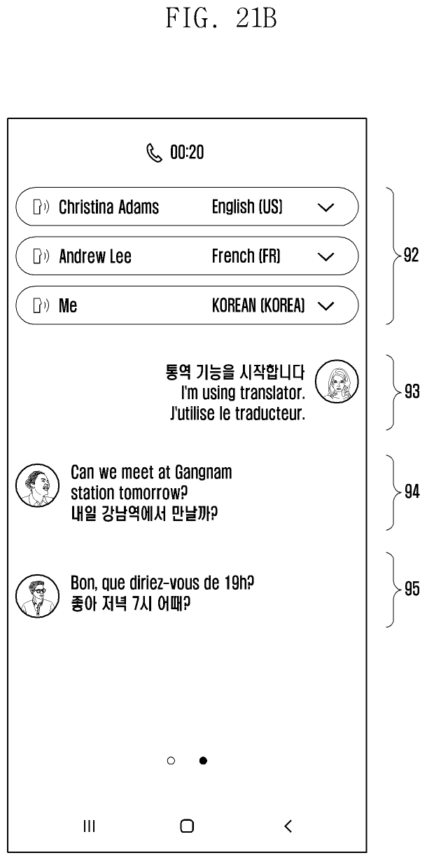

FIGS. 21A and 21B are diagrams illustrating an operation of executing an interpretation function in a conference call according to various embodiments of the disclosure.

Referring to FIG. 21A, a call screen of an electronic device 200 may include an item 91 for executing an interpretation function. The electronic device 200 may receive a user command to execute the interpretation function during a conference call (e.g., a multi-party call).

Referring to FIG. 21B, a conversation script according to execution of the interpretation function is illustrated. The conversation script may include an area 92 for displaying participant information and an area for displaying text. In an example, a user (Me) may use Korean, a first participant (e.g., Christina Adams) may use English, and a second participant (e.g., Andrew Lee) may use French.

When the interpretation function is executed, the electronic device 200 may display a notification according to execution of the interpretation function. The electronic device 200 may receive a Korean utterance from the user. The electronic device 200 may convert the received Korean utterance into text. The electronic device 200 may generate translated text in English, which is a language of the first participant, and translated text in French, which is a language of the second participant, by translating the received Korean utterance (or converted text). In addition, the electronic device 200 may display the text converted from the Korean utterance, the translated text in English, and the translated text in French 93 on the conversation script. The electronic device 200 may receive an English utterance from the first participant, and may convert the received English utterance into text. The electronic device 200 may generate translated text by translating the received English utterance (or converted text) into Korean, which is a language of the user. In addition, the electronic device 200 may display the text converted from the English utterance and the translated text in Korean 94 on the conversation script. The electronic device 200 may receive a French utterance from the second participant, and may convert the received French utterance into text. The electronic device 200 may generate translated text by translating the received French utterance (or converted text) into Korean, which is the language of the user. In addition, the electronic device 200 may display the text converted from the French utterance and the translated text in Korean 95 on the conversation script.

When the user speaks, the electronic device 200 may convert the user's utterance into text. The electronic device 200 may translate the user's utterance (or converted text) into English, which is the language of the first participant, and may generate an English TTS audio signal. The electronic device 200 may transmit the generated English TTS audio signal to the first participant. Simultaneously or sequentially, the electronic device 200 may translate the user's utterance (or converted text) into French, which is the language of the second participant, and may generate a French TTS audio signal. The electronic device 200 may transmit the generated French TTS audio signal to the second participant.

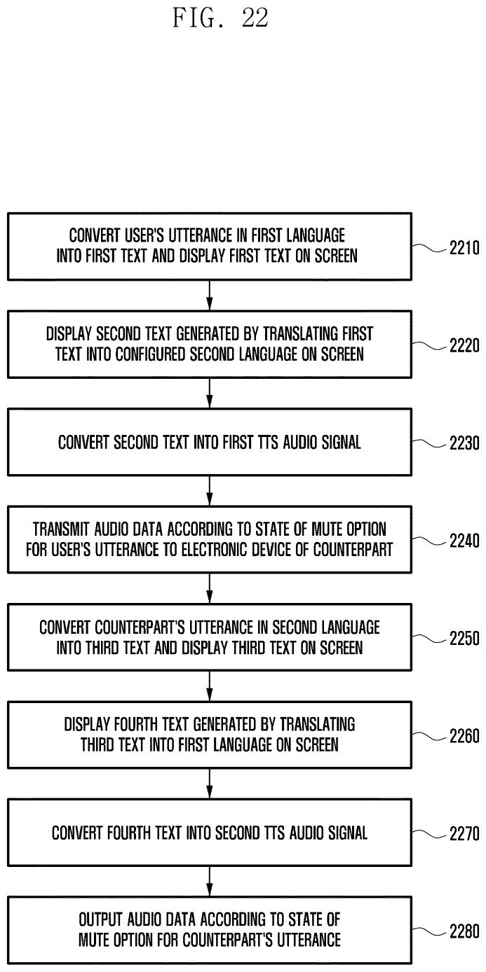

FIG. 22 is a flowchart illustrating a translation method during a call according to an embodiment of the disclosure.

In the following embodiments, operations may be sequentially performed but are not necessarily sequentially performed. For example, the order of the operations may be changed, and at least two operations may be performed in parallel.

According to an embodiment, operations 2210 to 2280 may be construed as being performed by a processor (e.g., the processor 250 of FIG. 2) of an electronic device (e.g., the electronic device 200 of FIG. 2).

Referring to FIG. 22, the electronic device 200 may convert an utterance of a user in a first language into first text and display the first text on a screen at operation 2210. For example, the electronic device 200 may generate a conversation script, and may display the first text on the conversation script.

The electronic device 200 may display second text generated by translating the first text into a second language on the screen at operation 2220. In an example, the electronic device 200 may translate the user's utterance into the second language. The second language may be a language configured as a language of a counterpart. In an example, the user's language may be Korean, and the counterpart's language may be English. The user may speak in Korean, and the first text may be in Korean. The electronic device 200 may translate the first text (or the user's utterance) into English to generate the second text. In addition, the electronic device 200 may display the generated second text together with the first text. In an example, the second text may be displayed in an area adjacent to the first text. The electronic device 200 may convert the second text into a first TTS audio signal at operation 2230. For example, the converted first TTS audio signal may be in English.

The electronic device 200 may transmit audio data according to a state of a mute option for the user's utterance to an electronic device of the counterpart at operation 2240. For example, when the mute option for the user's utterance is enabled, the electronic device 200 may transmit only the converted first TTS audio signal excluding the user's utterance via a communication interface. The electronic device 200 may transmit the converted first TTS audio signal to the electronic device of the counterpart through the communication interface. When the mute option for the user's utterance is disabled, the electronic device 200 may transmit the user's utterance and the converted first TTS audio signal via the communication interface. The electronic device 200 may transmit the user's utterance and the converted first TTS audio signal to the electronic device of the counterpart through the communication interface. In an example, the electronic device 200 may transmit the user's utterance to the electronic device of the counterpart when the user speaks, and may transmit the first TTS audio signal when the first TTS audio signal is generated. In an example, the electronic device 200 may record the user's utterance when the user speaks. In addition, when the first TTS audio signal is generated, the electronic device 200 may simultaneously transmit the user's utterance and the first TTS audio signal.

The electronic device 200 may convert an utterance of the counterpart in the second language into third text and display the third text on the screen at operation 2250. The electronic device 200 may receive the counterpart's utterance in the second language from the electronic device of the counterpart. The electronic device 200 may convert the received counterpart's utterance into the third text. For example, since the counterpart's language is English, the third text may be in English. The electronic device 200 may display the converted third text on the conversation script.

The electronic device 200 may display fourth text generated by translating the third text (or the counterpart's utterance) into the first language on the screen at operation 2260. In an example, the first language may be a language configured as the user's language. For example, the electronic device 200 may translate the counterpart's utterance in English (counterpart's language) into Korean (user's language) to generate the fourth text. The electronic device 200 may display the generated fourth text together with the third text. For example, the fourth text may be displayed in an area adjacent to the third text.

The electronic device 200 may convert the fourth text into a second TTS audio signal at operation 2270. For example, the converted second TTS audio signal may be in Korean.

The electronic device 200 may output audio data according to a state of a mute option for the counterpart's utterance at operation 2280. For example, when the mute option for the counterpart's utterance is enabled, the electronic device 200 may output only the converted second TTS audio signal excluding the counterpart's utterance. When the mute option for the counterpart's utterance is disabled, the electronic device 200 may output the counterpart's utterance and the converted second TTS audio signal. In an example, the electronic device 200 may output the counterpart's utterance when the counterpart speaks, and may output the second TTS audio signal when the second TTS audio signal is generated. In an example, the electronic device 200 may record the counterpart's utterance when the counterpart speaks. In addition, when the second TTS audio signal is generated, the electronic device 200 may sequentially output the counterpart's utterance and the second TTS audio signal. For example, the electronic device 200 may output the counterpart's utterance at a second level of volume, and may output the second TTS audio signal at a third level of volume greater than the second level. In addition, the electronic device 200 may apply an image effect to the fourth text in synchronization with a time when the second TTS audio signal is output.

For example, the electronic device 200 may include an option for selecting whether to transmit the second TTS audio signal to the counterpart. The second TTS audio signal may be an audio signal generated by translating the counterpart's utterance into the first language (user's language). In an example, when the transmission option for the second TTS audio signal is disabled, the electronic device 200 may not transmit the second TTS audio signal to the electronic device of the counterpart. In an example, when the transmission option for the second TTS audio signal is enabled, the electronic device 200 may transmit the second TTS audio signal to the electronic device of the counterpart.

The electronic device of the counterpart may output the received second TTS audio signal. In addition, the electronic device of the counterpart may output the user's utterance and the first TTS audio signal obtained by translating the user's utterance from the electronic device 200. In an example, the electronic device of the counterpart may output the user's utterance at a fifth level of volume, may output the first TTS audio signal at a sixth level of volume greater than the fifth level, and may output the second TTS audio signal at a fourth level of volume smaller than the fifth level.

For example, the electronic device 200 may output an audio signal in synchronization with a time when the electronic device of the counterpart outputs an audio signal. For example, when the electronic device of the counterpart outputs the first TTS audio signal, the electronic device 200 may also output the first TTS audio signal. The electronic device 200 may output the second TTS audio signal in synchronization with a time when the electronic device of the counterpart outputs the second TTS audio signal. In an example, the electronic device 200 may output the counterpart's utterance at the second level of volume, may output the first TTS audio signal at a first level of volume smaller than the second level, and may output the second TTS audio signal at the third level of volume greater than the second level.

In an example, an electronic device 200 may include a communication interface 240, a display 230, a speaker 220, at least one processor 250, and memory 210 storing instructions executed by the at least one processor 250. The instructions stored in the memory 210 may be configured to cause the electronic device 200 to convert an utterance of a counterpart in a first language into first text and display the first text on a script screen on the display during a call. The instructions stored in the memory 210 may be configured to cause the electronic device 200 to translate the first text into a second language to generate second text and display the second text together with the first text on the script screen. The instructions stored in the memory 210 may be configured to cause the electronic device 200 to convert the second text into a first text-to-speech (TTS) audio signal. The instructions stored in the memory 210 may be configured to cause the electronic device 200 to identify the utterance of the counterpart and output the first TTS audio signal through the speaker 220 without outputting the utterance of the counterpart in case that a first mute option for the utterance of the counterpart is enabled. The instructions stored in the memory 210 may be configured to cause the electronic device 200 to output the utterance of the counterpart and the first TTS audio signal through the speaker 220 in case that the first mute option for the utterance of the counterpart is disabled.

In an example, the instructions stored in the memory 210 may be configured to cause the electronic device 200 to convert an utterance of a user in the second language to third text and display the third text on the script screen during the call. The instructions stored in the memory 210 may be configured to cause the electronic device 200 to translate the third text into the first language to generate fourth text and display the fourth text together with the third text on the script screen. The instructions stored in the memory 210 may be configured to cause the electronic device 200 to convert the fourth text into a second TTS audio signal. The instructions stored in the memory 210 may be configured to cause the electronic device 200 to transmit the second TTS audio signal to a device of the counterpart through the communication interface 240 without transmitting the utterance of the user in case that a second mute option for the utterance of the user is enabled. The instructions stored in the memory 210 may be configured to cause the electronic device 200 to transmit the utterance of the user and the second TTS audio signal to the device of the counterpart through the communication interface 240 in case that the second mute option for the utterance of the user is disabled.

In an example, the instructions stored in the memory 210 may be configured to cause the electronic device 200 to transmit the utterance of the user to the device of the counterpart when the user speaks and transmit the second TTS audio signal to the device of the counterpart when the second TTS audio signal is converted, in case that the second mute option is disabled.

In an example, the instructions stored in the memory 210 may be configured to cause the electronic device 200 to store the utterance of the user in the memory 210 when the user speaks and transmit the utterance of the user and the second TTS audio signal to the device of the counterpart device when the second TTS audio signal is converted, in case that the second mute option is disabled.

In an example, the instructions stored in the memory 210 may be configured to cause the electronic device 200 to exclude translation of the first text in case that a translation option for the utterance of the counterpart is disabled and exclude translation of the third text in case that a translation option for the utterance of the user is disabled.

In an example, the instructions stored in the memory 210 may be configured to cause the electronic device 200 to change the language of the counterpart from the first language to a third language according to an input of the user during the call with the counterpart. The instructions stored in the memory 210 may be configured to cause the electronic device 200 to download data of the third language in case that the data of the third language is not stored in the memory. The instructions stored in the memory 210 may be configured to cause the electronic device 200 to translate the utterance of the user into the third language to generate fifth text and display the fifth text together with the third text on the script screen.

In an example, the instructions stored in the memory 210 may be configured to cause the electronic device 200 to output the second TTS audio signal in synchronization with a time when the first TTS audio signal is output from the device of the counterpart.

In an example, the instructions stored in the memory 210 may be configured to cause the electronic device 200 to output the utterance of the counterpart at a first level of volume and output the first TTS audio signal at a second level of volume greater than the first level.

In an example, the instructions stored in the memory 210 may be configured to cause the electronic device 200 to apply an image effect to the second text in synchronization with a time when the first TTS audio signal is output.

In an example, the instructions stored in the memory 210 may be configured to cause the electronic device 200 to delete text displayed first among text displayed on the script screen and display new text in case that a number of texts to be displayed exceeds a number texts displayable within an entire area of the script screen without scrolling.

In an example, a method performed by an electronic device including a screen may include converting an utterance of a counterpart in a first language into first text and displaying the first text on a script screen during a call. The method may include translating the first text into a second language to generate second text and displaying the second text together with the first text on the script screen. The method may include converting the second text into a first text-to-speech (TTS) audio signal. The method may include identifying the utterance of the counterpart and outputting the first TTS audio signal without outputting the utterance of the counterpart in case that a first mute option for the utterance of the counterpart is enabled. The method may include outputting the utterance of the counterpart and the first TTS audio signal in case that the first mute option for the utterance of the counterpart is disabled.

In an embodiment, the method may include converting an utterance of a user in the second language to third text and displaying the third text on the script screen during the call. The method may include translating the third text into the first language to generate fourth text and displaying the fourth text together with the third text on the script screen. The method may include converting the fourth text into a second TTS audio signal. The method may include transmitting the second TTS audio signal to a device of the counterpart without transmitting the utterance of the user in case that a second mute option for the utterance of the user is enabled. The method may include transmitting the utterance of the user and the second TTS audio signal to the device of the counterpart in case that the second mute option for the utterance of the user is disabled.

In an example, the transmitting to the device of the counterpart may include transmitting the utterance of the user to the device of the counterpart when the user speaks and transmitting the second TTS audio signal to the device of the counterpart when the second TTS audio signal is converted, in case that the second mute option is disabled.

In an example, the transmitting to the device of the counterpart may include storing the utterance of the user in memory when the user speaks and transmitting the utterance of the user and the second TTS audio signal to the device of the counterpart device when the second TTS audio signal is converted, in case that the second mute option is disabled.

In an example, the method may include excluding translation of the first text in case that a translation option for the utterance of the counterpart is disabled. The method may include excluding translation of the third text in case that a translation option for the utterance of the user is disabled.

In an example, the method may include changing the language of the counterpart from the first language to a third language according to an input of the user during the call with the counterpart. The method may include downloading data of the third language in case that the data of the third language is not stored. The method may include translating the utterance of the user into the third language to generate fifth text and display the fifth text together with the third text on the script screen.

In an example, the method may include outputting the second TTS audio signal in synchronization with a time when the first TTS audio signal is output from the device of the counterpart.

In an example, the outputting of the utterance of the user and the first TTS audio signal may include outputting the utterance of the counterpart at a first level of volume and outputting the first TTS audio signal at a second level of volume greater than the first level.

In an example, the method may include applying an image effect to the second text in synchronization with a time when the first TTS audio signal is output.

In an example, a non-transitory computer-readable recording medium storing a program to perform a method performed by an electronic device including a screen may include an instruction to perform an operation of converting an utterance of a counterpart in a first language into first text and displaying the first text on a script screen during a call. The recording medium may include an instruction to perform an operation of translating the first text into a second language to generate second text and displaying the second text together with the first text on the script screen. The recording medium may include an instruction to perform an operation of converting the second text into a first text-to-speech (TTS) audio signal. The recording medium may include an instruction to perform an operation of identifying the utterance of the counterpart and outputting the first TTS audio signal without outputting the utterance of the counterpart in case that a first mute option for the utterance of the counterpart is enabled. The recording medium may include an instruction to perform an operation of outputting the utterance of the counterpart and the first TTS audio signal in case that the first mute option for the utterance of the counterpart is disabled.

It should be appreciated that various examples of the disclosure and the terms used therein are not intended to limit the technological features set forth herein to particular examples and include various changes, equivalents, or replacements for a corresponding example. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it denotes that the element may be coupled with the other element directly (e.g., wiredly), wirelessly, or via a third element.

As used in connection with various examples of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an example, the module may be implemented in a form of an application-specific integrated circuit (ASIC).

Various examples as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an example, a method according to various examples of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various examples, each component (e.g., a module or a program) of the above-described components may include a single entity or multiple entities, and some of the multiple entities may be separately disposed in different components. According to various examples, one or more of the above-described components may be omitted, or one or more other components may be added. Alternatively or additionally, a plurality of components (e.g., modules or programs) may be integrated into a single component. In such a case, according to various examples, the integrated component may still perform one or more functions of each of the plurality of components in the same or similar manner as they are performed by a corresponding one of the plurality of components before the integration. According to various examples, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a communication interface;
a display;
a speaker;
at least one processor; and
memory, comprising one or more storage media, storing instructions,
wherein the instructions, when executed by the at least one processor individually or collectively, cause the electronic device to:
convert an utterance of a counterpart in a first language into first text, and display the first text on a script screen on the display during a call,
translate the first text into a second language to generate second text, and display the second text together with the first text on the script screen,
convert the second text into a first text-to-speech (TTS) audio signal,
in case that a first mute option for the utterance of the counterpart is enabled, identify the utterance of the counterpart, and output the first TTS audio signal through the speaker without outputting the utterance of the counterpart, and
in case that the first mute option for the utterance of the counterpart is disabled, output the utterance of the counterpart and the first TTS audio signal through the speaker.

2. The electronic device of claim 1, wherein the instructions, when executed by the at least one processor individually or collectively, further cause the electronic device to:
convert an utterance of a user in the second language to third text, and display the third text on the script screen during the call;
translate the third text into the first language to generate fourth text, and display the fourth text together with the third text on the script screen;
convert the fourth text into a second TTS audio signal;
in case that a second mute option for the utterance of the user is enabled, transmit the second TTS audio signal to a device of the counterpart through the communication interface without transmitting the utterance of the user; and
in case that the second mute option for the utterance of the user is disabled, transmit the utterance of the user and the second TTS audio signal to the device of the counterpart through the communication interface.

3. The electronic device of claim 2, wherein the instructions, when executed by the at least one processor individually or collectively, further cause the electronic device to:
in case that the second mute option is disabled, transmit the utterance of the user to the device of the counterpart when the user speaks, and transmit the second TTS audio signal to the device of the counterpart when the second TTS audio signal is converted.

4. The electronic device of claim 2, wherein the instructions, when executed by the at least one processor individually or collectively, further cause the electronic device to:
in case that the second mute option is disabled, store the utterance of the user in the memory when the user speaks, and transmit the utterance of the user and the second TTS audio signal to the device of the counterpart device when the second TTS audio signal is converted.

5. The electronic device of claim 2, wherein the instructions, when executed by the at least one processor individually or collectively, further cause the electronic device to:
in case that a translation option for the utterance of the counterpart is disabled, exclude translation of the first text, and in case that a translation option for the utterance of the user is disabled, exclude translation of the third text.

6. The electronic device of claim 2, wherein the instructions, when executed by the at least one processor individually or collectively, further cause the electronic device to:
change the language of the counterpart from the first language to a third language according to an input of the user during the call with the counterpart;
in case that data of the third language is not stored in the memory, download the data of the third language; and
translate the utterance of the user into the third language to generate fifth text, and display the fifth text together with the third text on the script screen.

7. The electronic device of claim 2, wherein the instructions, when executed by the at least one processor individually or collectively, further cause the electronic device to:
output the second TTS audio signal in synchronization with a time when the first TTS audio signal is output from the device of the counterpart.

8. The electronic device of claim 1, wherein the instructions, when executed by the at least one processor individually or collectively, further cause the electronic device to:
output the utterance of the counterpart at a first level of volume, and output the first TTS audio signal at a second level of volume greater than the first level.

9. The electronic device of claim 1, wherein the instructions, when executed by the at least one processor individually or collectively, further cause the electronic device to:
apply an image effect to the second text in synchronization with a time when the first TTS audio signal is output.

10. The electronic device of claim 1, wherein the instructions, when executed by the at least one processor individually or collectively, further cause the electronic device to:
in case that a number of texts to be displayed exceeds a number texts displayable over an entire area of the script screen without scrolling, delete previously displayed text and display new text.

11. A method performed by an electronic device comprising a screen, the method comprising:
converting an utterance of a counterpart in a first language into first text, and displaying the first text on a script screen during a call;
translating the first text into a second language to generate second text, and displaying the second text together with the first text on the script screen;
converting the second text into a first text-to-speech (TTS) audio signal;
in case that a first mute option for the utterance of the counterpart is enabled, identifying the utterance of the counterpart, and outputting the first TTS audio signal without outputting the utterance of the counterpart; and
in case that the first mute option for the utterance of the counterpart is disabled, outputting the utterance of the counterpart and the first TTS audio signal.

12. The method of claim 11, further comprising:
converting an utterance of a user in the second language to third text, and displaying the third text on the script screen during the call;
translating the third text into the first language to generate fourth text, and displaying the fourth text together with the third text on the script screen;
converting the fourth text into a second TTS audio signal;
in case that a second mute option for the utterance of the user is enabled, transmitting the second TTS audio signal to a device of the counterpart without transmitting the utterance of the user; and
in case that the second mute option for the utterance of the user is disabled, transmitting the utterance of the user and the second TTS audio signal to the device of the counterpart.

13. The method of claim 12, wherein the transmitting to the device of the counterpart comprises:
in case that the second mute option is disabled, transmitting the utterance of the user to the device of the counterpart when the user speaks, and transmitting the second TTS audio signal to the device of the counterpart when the second TTS audio signal is converted.

14. The method of claim 12, wherein the transmitting to the device of the counterpart comprises:
in case that the second mute option is disabled, storing the utterance of the user in memory when the user speaks, and transmitting the utterance of the user and the second TTS audio signal to the device of the counterpart device when the second TTS audio signal is converted.

15. The method of claim 12, further comprising:
in case that a translation option for the utterance of the counterpart is disabled, exclude translation of the first text, and in case that a translation option for the utterance of the user is disabled, exclude translation of the third text.

16. The method of claim 12, further comprising:
change the language of the counterpart from the first language to a third language according to an input of the user during the call with the counterpart;
in case that data of the third language is not stored in memory, download the data of the third language; and
translate the utterance of the user into the third language to generate fifth text, and display the fifth text together with the third text on the script screen.

17. The method of claim 12, further comprising:
output the second TTS audio signal in synchronization with a time when the first TTS audio signal is output from the device of the counterpart.

18. The method of claim 11, further comprising:
output the utterance of the counterpart at a first level of volume, and output the first TTS audio signal at a second level of volume greater than the first level.

19. One or more non-transitory computer-readable storage media storing one or more computer programs including computer-executable instructions that, when executed by one or more processors of an electronic device individually or collectively, cause the electronic device to perform operations, the operations comprising:
converting an utterance of a counterpart in a first language into first text, and displaying the first text on a script screen during a call;
translating the first text into a second language to generate second text, and displaying the second text together with the first text on the script screen;
converting the second text into a first text-to-speech (TTS) audio signal;
in case that a first mute option for the utterance of the counterpart is enabled, identifying the utterance of the counterpart, and outputting the first TTS audio signal without outputting the utterance of the counterpart; and
in case that the first mute option for the utterance of the counterpart is disabled, outputting the utterance of the counterpart and the first TTS audio signal.

20. The one or more non-transitory computer-readable storage media of claim 19, the operations further comprising:
converting an utterance of a user in the second language to third text, and displaying the third text on the script screen during the call;
translating the third text into the first language to generate fourth text, and displaying the fourth text together with the third text on the script screen;
converting the fourth text into a second TTS audio signal;
in case that a second mute option for the utterance of the user is enabled, transmitting the second TTS audio signal to a device of the counterpart without transmitting the utterance of the user; and
in case that the second mute option for the utterance of the user is disabled, transmitting the utterance of the user and the second TTS audio signal to the device of the counterpart.
